(19) United States
(12) Patent Application Publication
(10) Pub. No.: US 2026/0311004 A1
(43) Pub. Date: Oct. 8, 2026

(54) SYSTEMS AND METHODS FOR EVALUATING ARTIFICIAL INTELLIGENCE OUTPUTS THROUGH HIERARCHICAL TASK DECOMPOSITION, BIDIRECTIONAL REASONING VERIFICATION, GOAL INFERENCE WITH DRIFT DETECTION, AND MULTI-DIMENSIONAL SAFETY-EFFECTIVENESS SCORING

(71) Applicant: Jared Lamb, Reisterstown, MD (US)

(72) Inventor: Jared Lamb, Reisterstown, MD (US)

(21) Appl. No.: 19/642,104

(22) Filed: Apr. 8, 2026

Related U.S. Application Data
(60) Provisional application No. 63/785,560, filed on Apr. 8, 2025.
(60) Provisional application No. 63/788,936, filed on Apr. 15, 2025.
(60) Provisional application No. 63/814,378, filed on May 29, 2025.
(60) Provisional application No. 63/875,102, filed on Sep. 3, 2025.

(51) Int. Cl. G06N 5/04

(52) U.S. Cl. CPC G06N 5/04

(57) ABSTRACT

Systems and methods evaluate artificial intelligence outputs through automated hierarchical task decomposition and multi-dimensional scoring. A task decomposition engine identifies constituent tasks with task boundaries and inter-task dependencies. A bidirectional verification system performs forward decomposition from input to tasks and reverse decomposition from output to tasks, detecting hidden processing through discrepancy analysis. A goal inference module tracks goal evolution during reasoning and detects drift and misalignment. A bounded execution constraint system determines constraints based on safety risk factors and communicates finite processing horizons to suppress emergent long-horizon goals. A safety-weighted routing system distributes tasks across AI systems using multi-factor optimization with safety as an explicit dimension. An effectiveness measurement system maps tasks to human-equivalent performance baselines with empirically-calibrated estimates and quality assessment. An integrated dual-pathway architecture processes tasks through parallel safety and effectiveness pathways with configurable weighting, enabling unified evaluation through shared decomposition.

### CROSS-REFERENCE TO RELATED APPLICATIONS

This application claims the benefit of U.S. Provisional Patent Application No. 63/785,560, entitled “SYSTEMS AND METHODS FOR DETERMINING RETURN ON INVESTMENT OF ARTIFICIAL INTELLIGENCE INTERACTIONS THROUGH TASK DECOMPOSITION,” filed Apr. 8, 2025 (Docket No. 2025-PROBS-014), U.S. Provisional Patent Application No. 63/814,378, entitled “SYSTEMS AND METHODS FOR AI-BASED SEARCH RANKING, TRUST VERIFICATION, AND MULTI-AI ARBITRATION WITH WEBSITE AMBASSADORS,” filed May 29, 2025 (Docket No. 2025-PROBS-003), U.S. Provisional Patent Application No. 63/875,102, entitled “SYSTEMS AND METHODS FOR INTELLIGENT CONTEXT MANAGEMENT OF ARTIFICIAL INTELLIGENCE APPLICATIONS WITH CONTEXT-PROMPT-RESPONSE TRIPLET ARCHITECTURE, TEMPORAL-IMPORTANCE GRADIENT COMPRESSION, AND HIERARCHICAL CONTEXT AND RESPONSE GENERATION,” filed Sep. 3, 2025 (Docket No. 2025-PROBS-017), U.S. Provisional Patent Application No. 64/005,621, entitled “SYSTEMS AND METHODS FOR COMPUTING NET RETURN ON INVESTMENT OF ARTIFICIAL INTELLIGENCE INTERACTIONS THROUGH USAGE-BASED COST QUANTIFICATION, HUMAN INTERACTION TIME INVESTMENT TRACKING, SUBSCRIPTION COST AMORTIZATION, BIDIRECTIONAL VALUE ACCOUNTING, AND AUTOMATED SYSTEM-CONTROL OUTPUTS,” filed Mar. 14, 2026 (Docket No. 2026-PROBS-016), and U.S. Provisional Patent Application No. 63/788,936, entitled “SYSTEMS AND METHODS FOR EVALUATING ARTIFICIAL INTELLIGENCE SAFETY THROUGH TASK DECOMPOSITION AND GOAL INFERENCE,” filed Apr. 15, 2025 (Docket No. 2025-PROBS-015), each of which is incorporated herein by reference in its entirety. This application claims the benefit of U.S. Provisional Patent Application Nos. 63/785,560, 63/814,378, 63/875,102, 64/005,621, and 63/788,936 under 35 U.S.C. § 119 (e).

The applicant reserves the right to file one or more continuation applications, continuation-in-part applications, and divisional applications claiming priority to this application and to the provisional applications referenced above.

### FIELD OF THE INVENTION

The present disclosure relates generally to systems and methods for evaluating artificial intelligence system outputs and reasoning processes. More specifically, the present disclosure relates to automated evaluation of AI outputs through hierarchical task decomposition, bidirectional reasoning verification, goal inference and alignment monitoring during inference-time computation, safety-aware multi-agent task routing, and multi-dimensional effectiveness scoring against human-equivalent performance baselines.

### BACKGROUND OF THE INVENTION

With the proliferation of artificial intelligence technologies across industries and applications, organizations and individuals face a growing need to evaluate AI system outputs along multiple dimensions, including safety, alignment, effectiveness, and economic value, in an automated, scalable, and technically rigorous manner. Existing approaches to AI output evaluation suffer from several significant limitations.

Current limitations of existing approaches include without limitation the following:
1. Existing AI output evaluation systems typically rely on single-dimensional metrics such as perplexity scores, factual accuracy measures, or individual reasoning step correctness ratings that decompose outputs into atomic facts or isolated reasoning steps but fail to capture the multi-faceted task-level structure of complex AI outputs, including task boundaries, inter-task dependencies, and compositional relationships among discrete units of work;
2. Current approaches generally treat AI outputs as monolithic units or sequences of tokens rather than as structured compositions of discrete tasks with heterogeneous characteristics, varying complexity levels, and domain-specific considerations, thereby losing granularity essential for meaningful evaluation;
3. Existing chain-of-thought verification methods analyze reasoning traces in a single direction, typically forward from input to output, without independent reverse verification from outputs back to inferred processing steps, leaving systematic gaps in the ability to detect undocumented processing, hidden tasks, and reasoning that an AI system may have performed but not reported in its explicit reasoning chain;
4. Current AI alignment monitoring approaches operate predominantly on final outputs produced by AI systems rather than tracking goal formation and evolution during inference-time reasoning processes, thereby preventing early detection of goal drift, misalignment with stated objectives, emergence of hidden objectives, or other potentially problematic patterns before they manifest in outputs delivered to users;
5. Existing multi-agent AI orchestration systems optimize task routing across multiple AI models or agents based on cost and capability dimensions but traditionally lack safety as an explicit weighted optimization factor in routing decisions, creating blind spots in regulated, high-risk, or safety-critical deployments where the safety profile of the AI system processing a given task may be as important as or more important than cost or capability considerations;
6. Current methods for assessing AI effectiveness rely on aggregate economic analysis using pre-existing occupational task taxonomies and human expert annotation to predict potential AI impact across workforces or task categories, rather than automated per-output evaluation of what a specific AI interaction actually accomplished, creating a gap between potential impact studies and operational measurement of realized value;
7. No existing system integrates safety evaluation and effectiveness measurement through a shared task decomposition architecture, forcing organizations to operate parallel evaluation systems with redundant decomposition analysis, inconsistent task taxonomies, and separate reporting frameworks that cannot provide unified assessments balancing safety and effectiveness considerations; and
8. Traditional approaches to measuring AI productivity fail to account for empirically-documented variance in AI effectiveness across task types, complexity levels, and user expertise levels, applying uniform assumptions that systematically overestimate the value of AI assistance for expert users and complex tasks while underestimating the value for routine tasks and less experienced users, and failing to identify task profiles where AI assistance provides zero or negative benefit.

Accordingly, there remains a need for systems and methods that evaluate AI outputs through automated task decomposition at a granularity that captures task boundaries and inter-task dependencies, that verify reasoning faithfulness through bidirectional analysis comparing what an AI system reported against what it must have done, that monitor goal alignment during inference-time computation with real-time drift detection and intervention capabilities, that route tasks across multiple AI systems with safety as an explicit optimization dimension, and that measure per-output effectiveness against empirically-grounded human performance baselines through a unified evaluation framework integrating both safety and effectiveness dimensions.

### SUMMARY OF THE INVENTION

The present disclosure addresses the aforementioned limitations by providing systems and methods for evaluating artificial intelligence outputs through hierarchical task decomposition, bidirectional reasoning verification, goal inference with drift detection, and multi-dimensional safety-effectiveness scoring.

### Non-Limiting Primary Innovations

The present disclosure includes the following non-limiting primary innovations:
1. Hierarchical Task Decomposition Engine: A task decomposition engine configured to analyze AI outputs and identify constituent task representations with task boundaries, inter-task dependencies, task type classification, and complexity assessment, operating at a task-value abstraction layer that captures discrete units of work performed by or reflected in the AI output, distinct from systems that decompose outputs into atomic facts for factual verification or that score individual reasoning steps for correctness;
2. Bidirectional Reasoning Verification System: A system that performs parallel forward decomposition from input prompt and reasoning trace to a first set of identified tasks and reverse decomposition from output to a second set of inferred necessary tasks, with a comparison engine detecting discrepancies including omitted tasks, logical inconsistencies, and resource allocation anomalies, and a hidden task detection module generating classified risk indicators for processing steps that were performed but not documented;
3. Goal Inference and Drift Detection System: A goal inference module that maps decomposed task patterns to ranked goal hypotheses with confidence scores, tracks goal evolution over successive reasoning steps during inference-time computation to detect drift and emergence of new objectives, evaluates alignment against stated objectives, and triggers configurable intervention when misalignment exceeds established thresholds;
4. Bounded Execution Constraint System for Goal Shaping: A system that determines execution constraints based on safety-related risk factors associated with AI processing tasks, rather than solely problem complexity or cost optimization, and communicates finite processing horizons to AI systems including explicit termination signaling without continuation, thereby suppressing emergent long-horizon goal formation by removing the planning horizon needed for complex, extended, or potentially problematic goal pursuit;
5. Safety-Weighted Multi-Agent Task Routing: A routing system that distributes decomposed tasks across multiple AI systems using multi-factor optimization incorporating safety compliance as an explicit weighted dimension alongside capability matching, cost, and performance, with safety weighting that increases for higher-risk tasks, dynamic rerouting when risk thresholds are exceeded during execution, and output validation requiring multi-agent consensus for high-risk outputs;
6. Task-Based Effectiveness Measurement System: A system that automatically decomposes individual AI outputs into constituent tasks and maps each to human-equivalent performance baselines including professional role classification, estimated completion time calibrated against empirical reference distributions, and cost parameters, operating on actual outputs in real time rather than predicting potential AI impact against pre-existing occupational task taxonomies with human expert annotation; and
7. Integrated Dual-Pathway Evaluation Architecture: An architecture that processes decomposed tasks from a shared decomposition engine through parallel safety evaluation and effectiveness evaluation pathways, with a configurable integration module that applies adjustable weighting between safety and effectiveness dimensions to produce composite assessments supporting holistic evaluation of AI system performance.

### Key Technical Advantages May Include Without Limitation

Key technical advantages of the present disclosure may include without limitation:
1. Task-level evaluation granularity that captures inter-task dependencies and composition effects, providing structured evaluation beyond what atomic-fact decomposition or step-level scoring provides;
2. Detection of undocumented AI processing through bidirectional comparison of forward and reverse decomposition results, a capability that single-direction analysis cannot achieve;
3. Early intervention in AI reasoning processes before problematic outputs are generated, enabled by real-time goal inference and drift detection during inference-time computation;
4. Safety-aware task routing addressing a gap in existing orchestration systems that optimize only for cost and capability;
5. Empirically-grounded effectiveness measurement calibrated against reference distributions derived from published research rather than unconstrained estimation;
6. Identification of task and expertise profiles where AI assistance provides zero or negative benefit, preventing systematic overestimation of AI value;
7. Unified evaluation through shared task decomposition eliminating redundant analysis across safety and effectiveness assessments; and
8. Applicability across diverse AI system types, deployment architectures, and evaluation contexts including without limitation standalone applications, API integrations, embedded components within AI platforms, browser extensions, and mobile applications.

### BRIEF DESCRIPTION OF THE DRAWINGS

FIG. 1 is a block diagram illustrating an example embodiment of the overall system architecture for AI output evaluation through hierarchical task decomposition, showing the task decomposition engine 110, bidirectional verification system 120, goal inference module 130, risk detection framework 140, intervention control system 150, multi-agent routing layer 160, effectiveness measurement system 170, integrated evaluation module 180, data store and audit system 190, and reporting module 195, with primary data flow indicated by solid arrows and feedback or control mechanisms indicated by dashed arrows.

FIG. 2 is a block diagram illustrating an example embodiment of the bidirectional reasoning verification process, showing forward decomposition module 220 analyzing an input prompt and reasoning trace to produce a first task set 225, reverse decomposition module 230 analyzing an output to produce a second task set 234, comparison engine 240 evaluating discrepancies between the first and second task sets, and hidden task detection module 250 generating classified risk indicators with confidence scores.

FIG. 3 is a block diagram illustrating an example embodiment of the integrated dual-pathway evaluation architecture, showing AI interaction 710 entering shared task decomposition engine 720, which feeds both safety evaluation pathway 730 (including bidirectional verification, goal inference, and risk assessment) and effectiveness evaluation pathway 740 (including task classification, human-equivalent mapping, time-cost estimation, and quality assessment), with configurable integration module 750 applying adjustable weighting between safety and effectiveness dimensions to produce composite evaluation output 760.

### DETAILED DESCRIPTION OF THE INVENTION

### Definitions (Non-limiting, Included for Convenience)

The following definitions are provided for convenience and are not intended to limit the scope of the claims. These terms are used throughout this disclosure with the meanings indicated below, unless context clearly requires otherwise.

“Constituent task representation” refers to a structured representation of a discrete unit of work identified within an AI output, comprising at least a task type, a complexity classification, task boundaries, and inter-task dependency relationships. A constituent task representation is distinct from an “atomic fact,” which is a single verifiable statement extracted from text, and distinct from a “reasoning step,” which is a single inferential operation in a chain of thought. A constituent task representation captures what work was done, not merely what was stated or what logical step was taken.

“Task boundary” refers to a detected semantic, structural, or functional demarcation between discrete units of work within an AI output. Task boundaries separate constituent task representations from one another and may be detected through semantic shift analysis, structural markers, transitional indicators, topic changes, methodology changes, or other signals.

“Inter-task dependency” refers to a relationship between two or more constituent task representations indicating sequential, parallel, hierarchical, conditional, or other execution or logical relationships.

“Forward decomposition” refers to analysis proceeding from an input prompt, instructions, or context, together with any available reasoning trace or chain-of-thought output, to identify tasks the AI system performed or purported to perform in generating its output.

“Reverse decomposition” refers to analysis proceeding from an AI-generated output to infer, independently of any reasoning trace, a set of tasks that would be necessary to produce that output.

“Hidden task” refers to a processing step, reasoning operation, or computational activity inferred to have been performed by an AI system but not documented, reported, or reflected in the system's explicit reasoning trace or self-reported reasoning artifacts.

“Goal drift” refers to a change in one or more inferred goal hypotheses attributed to an AI system over successive reasoning steps during a single inference-time computation session.

“Safety compliance rating” refers to a stored metric reflecting an AI system's historical performance against one or more safety evaluation criteria.

“Execution constraint” refers to a communicated limit on one or more parameters of AI processing, including without limitation reasoning step count, token count, time allocation, computational cost, or model interaction depth, determined based at least in part on safety-related risk factors rather than determined solely by problem complexity or cost optimization objectives.

“Human-equivalent mapping” refers to the automated association of a constituent task representation with one or more professional roles and corresponding estimated human completion times based on the task classification, performed by the system's mapping engine rather than by reference to a pre-existing external occupational task taxonomy maintained by a third party.

“Evaluation vector” refers to a multi-dimensional representation of scores or metrics across a plurality of evaluation dimensions generated for a constituent task representation.

“Quality assessment” refers to the evaluation of an AI output or constituent task along one or more quality dimensions including without limitation accuracy, completeness, coherence, relevance, adherence to instructions, factual correctness, stylistic appropriateness, and compliance with domain-specific standards. Quality assessment may be performed through rubric-based scoring, reference-output comparison, policy-compliance verification, model-consensus evaluation, or combinations thereof.

As used herein, terms such as “optimal,” “optimize,” “maximize,” and “minimize” denote operations configured to tend toward improved values for one or more objectives relative to a baseline or alternative, possibly under constraints. No embodiment requires a global or unique optimum; approximate, heuristic, learned, threshold-based, or Pareto-efficient solutions are contemplated.

No claim element herein is to be construed under 35 U.S.C. § 112 (f) unless the element explicitly uses the phrase “means for” or “step for.”

Throughout this specification and claims, lists of items introduced with phrases such as “at least one of,” “one or more of,” or similar language should be interpreted to include any single item from the list, any combination of items from the list, or all items from the list, unless specifically stated otherwise. The terms “comprising,” “including,” and “having” are intended to be inclusive, such that the presence of additional elements or components beyond those expressly recited is not excluded.

### 1. System Architecture Overview

### 1.1 Overall System Architecture

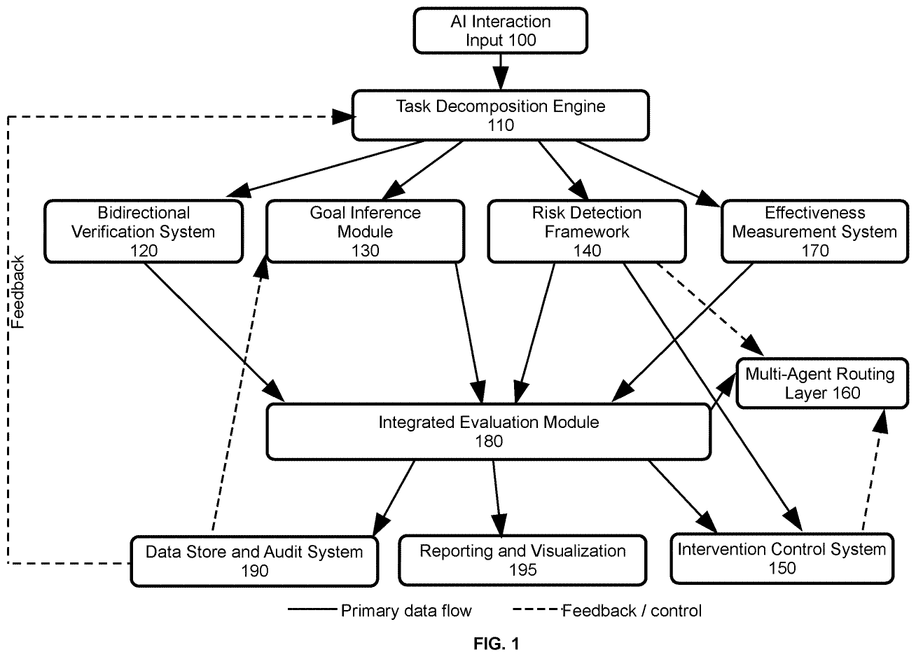

Referring now to FIG. 1, an example embodiment of the overall system architecture for AI output evaluation is illustrated. The system receives AI interactions at input 100, which may include without limitation one or more of: an input prompt to an artificial intelligence system; an output response from an artificial intelligence system; a combination of an input prompt and an output response; a chain of reasoning produced by an artificial intelligence system during inference-time computation; internal monologue or extended thinking produced by an artificial intelligence system; a dialogue between two or more artificial intelligence systems or between an artificial intelligence system and itself; a human-described or AI-generated description of an AI interaction; or combinations thereof.

The AI interaction input 100 is received by a task decomposition engine 110, which analyzes the interaction and identifies a plurality of constituent task representations as described in detail in Section 2 below. The task decomposition engine 110 is the shared analytical foundation of the system, producing structured task representations that are consumed by multiple downstream modules.

The output of the task decomposition engine 110 feeds into multiple analytical modules operating in parallel, sequentially, or in configurable combinations depending on the deployment context. In various embodiments, the decomposition output feeds into one or more of: a bidirectional verification system 120 (Section 3); a goal inference module 130 (Section 4); a risk detection framework 140 (Section 6); an effectiveness measurement system 170 (Section 8); and an integrated evaluation module 180 (Section 9).

When the risk detection framework 140 identifies potential safety concerns, an intervention control system 150 may dynamically modify the AI reasoning process. In various embodiments, intervention may include without limitation halting computation, re-routing one or more tasks to alternative AI systems through a multi-agent routing layer 160, or injecting execution constraints as described in Section 5.

The effectiveness measurement system 170 maps decomposed tasks to human-equivalent performance baselines including professional role classification, estimated completion time, and cost parameters, as described in Section 8.

The integrated evaluation module 180 receives outputs from both safety-oriented modules and the effectiveness measurement system 170, producing composite evaluations through configurable weighting between safety and effectiveness dimensions, as described in Section 9. In some embodiments, safety considerations may override effectiveness-based assessments when safety metrics exceed critical thresholds.

A data store and audit system 190 persistently stores all analysis results, decomposed tasks, inferred goals, risk assessments, intervention records, effectiveness metrics, and composite evaluations. In various embodiments, all interventions, reasoning chains, goal estimates, and other system data may be logged, hashed, and made available for compliance auditing. A reporting and visualization module 195 transforms analytical data into actionable insights through reports, dashboards, and exportable visualizations.

Feedback loops throughout the system, indicated by dashed arrows in FIG. 1, enable continuous refinement. In various embodiments, user feedback, confirmed hidden task detections, verified goal drift instances, and actual human completion times may feed back into modules to improve future evaluations through supervised learning, Bayesian updating, or other adaptive mechanisms.

### 1.2 Input Modes and Flexible Data Handling

The system is configured to operate across multiple input modes reflecting diverse data availability contexts. In certain embodiments, only the AI-generated output is available. The task decomposition engine 110 is configured to infer constituent tasks by analyzing the structure, semantics, composition, arrangement, subject matter, and complexity of the output content.

In another embodiment, only the prompt is available. The system may estimate likely tasks by referencing prior prompt-response mappings, semantic templates, or AI-instruction matching models.

In a further embodiment, both the prompt and the resulting AI output are available. The system may cross-reference the prompt's intent with the observed output for higher-fidelity decomposition. In certain configurations, the prompt may instruct the AI to output a task list or summary of its internal processes, enabling a self-reported decomposition that can be validated against the system's independent analysis.

In various embodiments, the system further supports chain-of-reasoning inputs, internal monologue traces, dialogues between multiple AI systems, and external usage descriptions. An input handler module routes each input type to appropriate decomposition and evaluation modules.

### 1.3 Deployment Architectures

In various embodiments, the system may be implemented through multiple architectural approaches including without limitation: standalone web or desktop applications; API-first architectures for third-party integration; embedded components within AI platforms; browser extensions that detect and capture AI interactions across web-based platforms; mobile applications; and hybrid architectures. The present disclosure is not limited to any particular deployment architecture.

### 1.4 Implementation-Level Technical Operations

The following subsection describes the concrete technical mechanisms by which the system's modules interact with AI systems and with each other during operation. These implementation details are provided as non-limiting example embodiments illustrating how the system's functional capabilities may be realized at the infrastructure level.

Pipeline Positioning and Interception: In various embodiments, the evaluation system operates as an interception layer positioned between the AI model's reasoning engine and the output delivery endpoint. In one non-limiting example embodiment, the interception layer receives reasoning tokens as they are generated by the AI model's inference process, either through a streaming API that exposes intermediate tokens, through access to the model's output buffer before delivery to the end user, through a proxy layer that intercepts API responses between the AI system and the requesting client, through instrumentation hooks embedded within the AI platform's inference pipeline, or through a combination or alternative method. The interception layer captures the reasoning trace and output data without modifying the AI system's core inference computation, enabling evaluation to proceed in parallel with or immediately following generation. In other embodiments, the evaluation system operates post-hoc on completed outputs retrieved from logs, databases, APIs, user-submitted transcripts, or similar outputs, without real-time interception. In other embodiments, the evaluation system may be integrated directly into the inference pipeline.

Intervention Execution Mechanisms: When the intervention control system 150 determines that intervention is warranted based on risk detection, the system executes concrete machine operations to modify the AI processing pipeline. In various embodiments, a halt intervention is executed by transmitting a stop signal to the AI model's inference process, such as through an API cancellation call, through suppression of further token generation in the output buffer, or through termination of the inference session at the platform level. In various embodiments, the AI model's API or tool access may be restricted or blocked. A reroute intervention is executed by packaging the current interaction context, including the original prompt, any partial output, relevant metadata, and task-specific parameters, into a structured context object, selecting a target AI system from the capability and safety profile database 320 based on the routing optimization described in Section 7, and transmitting the context object to the target system's API endpoint to initiate processing by the replacement system. In various embodiments only the original prompt is transmitted to the target system. A constraint intervention is executed by injecting constraint text into the AI model's input context, such as appended to the system prompt, inserted as a user-turn message, or delivered via a platform-specific parameter field, before the model continues or restarts its inference process. The constraint text explicitly states the execution boundary and termination conditions in natural language that the model processes as part of its input. In alternative embodiments, constraints may be imposed onto the inference pipeline itself such as a cap on maximum context length, maximum reasoning length, or layer reduction.

Routing Decision Implementation: When the multi-factor routing engine 340 selects a target AI system for a constituent task, the routing decision is translated into a concrete API interaction. In one non-limiting example embodiment, the routing execution module generates a request payload comprising the task-specific prompt derived from the decomposed task, the relevant context extracted by the context management system, authentication credentials for the target system's API, and configuration parameters including model selection, temperature, maximum token count, and any applicable safety constraints. The module transmits this payload to the target system's API endpoint via HTTPS, receives the response, and integrates the response into the overall processing pipeline. For parallel processing configurations, the module dispatches requests to multiple target systems concurrently and collects responses for downstream comparison or aggregation by the output validation module 370. In an alternative embodiment, the module transmits only the task-specific prompt derived from the decomposed task and optionally relevant context extracted by the context management system.

Audit State Generation: Each decision point in the system's processing pipeline generates a structured audit record. In one non-limiting example embodiment, each audit record comprises a unique record identifier, a timestamp, a module identifier indicating which system component generated the record, a hash of the input data processed at the decision point, a hash of the output or decision produced, the decision outcome or action taken, confidence scores associated with the decision, and a reference to the immediately-preceding audit record's hash, creating a hash chain that enables tamper detection across the processing sequence. Audit records are written to the data store 190 in an append-only mode. In various embodiments, the hash chain may employ SHA-256 or equivalent cryptographic hash functions, and the complete audit trail may be exported in structured formats for compliance review, regulatory submission, or forensic analysis. In alternative embodiments, audit records may be stored without hash chaining, using alternative integrity verification mechanisms including without limitation digital signatures, append-only database guarantees, or third-party attestation services.

Model-to-Model Communication: When the system requires one AI model to analyze, evaluate, or probe the output of another AI model, as in the forward decomposition, reverse decomposition, self-analysis, multi-agent voting, or active probing mechanisms described herein, the communication may be implemented through API calls. In one non-limiting example embodiment, the originating module constructs a prompt for the evaluating model that includes the content to be analyzed (such as a reasoning trace, output, or suspected hidden task), any relevant context or instructions, and a response format specification directing the evaluating model to return its analysis in a structured format (such as JSON) that the originating module can parse programmatically. The evaluating model processes this prompt through its standard inference pathway and in some embodiments returns a structured response that is deserialized and consumed by the originating module. In various embodiments, multiple evaluating models may be invoked in parallel, and their responses may be compared, aggregated, or subjected to voting protocols as described in Section 7.6. In alternative embodiments, model-to-model communication may occur through shared memory, internal function calls, message queues, or other inter-process communication mechanisms rather than external API calls.

### 2. Hierarchical Task Decomposition Engine

### 2.1 Task Decomposition Process

In one embodiment, the task decomposition engine 110 analyzes artificial intelligence interactions and identifies constituent task representations. The engine employs one or more of natural language processing techniques, machine learning models, heuristic rules, or combinations thereof.

The task decomposition process may include one or more of, but is not limited to, the following operations in various embodiments:
1. Initial Parsing: Parsing of the AI interaction to identify key components including without limitation actions, instructions, content creation outputs, data analysis results, reasoning steps, decision points, tool usage, API calls, code segments, inputs and outputs, and other indicators of discrete work units;
2. Semantic Boundary Detection: Semantic analysis to identify task boundaries based on semantic shifts, topic transitions, methodology changes, structural markers, content changes, and transitional indicators. In one non-limiting example embodiment, the boundary detection mechanism analyzes attention-weighted token representations in a transformer-based model to identify points where semantic content shifts from one work domain or task type to another;
3. Inter-Task Dependency Analysis: Analysis to determine relationships between identified tasks including sequential dependencies, hierarchical relationships, parallel operations, conditional relationships, and compositional relationships including but not limited to where multiple tasks combine to produce a unified deliverable;
4. Implicit Sub-Task Identification: Identification of implicit sub-tasks necessary to complete the work reflected in the AI output, including tasks a human would need to perform that the AI completed implicitly. In one non-limiting example, if an AI response includes specialized knowledge, the system may identify implied research tasks;
5. Task Classification: Classification of each identified task into categories including without limitation research, writing, analysis, calculation, design, coding, debugging, editing, formatting, planning, decision support, and operations, with a hierarchical taxonomy enabling both broad and fine-grained evaluation;
6. Complexity Assessment: Assessment of each task's complexity based on factors including word count, technical depth, creative requirements, analytical complexity, quality standards, and domain specialization;
7. Granularity Adjustment: Adjustment to ensure tasks are identified at an appropriate level of detail for accurate evaluation. In various embodiments, the target granularity may produce between approximately one and twelve constituent task representations per interaction, though this range is non-limiting and higher task counts are allowed in alternative embodiments; and
8. Context Analysis: Analysis of domain-specific considerations affecting task composition and evaluation.

### 2.2 Task Taxonomy and Classification

In various embodiments, the task decomposition engine 110 employs a hierarchical task taxonomy. In one non-limiting example embodiment, the taxonomy comprises major task categories including without limitation drafting, research, coding, analysis, planning, editing, decision support, and operations, with each category encompassing multiple specific task types selected based on availability of empirical time data.

In certain embodiments, each classified task is further assessed for complexity level. The combination of task type and complexity level defines a cell in the system's estimation space, enabling targeted calibration and confidence scoring for each type-complexity combination.

The task decomposition engine 110 identifies task representations as discrete units of work with boundaries and dependencies, distinct from systems that decompose outputs into atomic facts for factual accuracy verification or that score individual reasoning steps for mathematical or logical correctness. The present disclosure operates at a task-value abstraction layer, capturing what work was accomplished rather than whether individual statements are true or individual reasoning steps are valid.

### 2.3 Inter-Task Dependency Detection

In various embodiments, the task decomposition engine 110 includes a dependency analysis module 114 configured to identify and characterize relationships among constituent task representations. Dependencies may be classified into types including without limitation:

sequential dependencies; hierarchical dependencies; parallel relationships; conditional relationships; and compositional relationships.

In various embodiments, the identified dependencies inform downstream evaluation. In the effectiveness pathway, dependencies influence how individual task evaluations aggregate, accounting for coordination overhead, context-switching costs, and integration effort not reflected in simple summation. In the safety pathway, dependency structures may reveal complex task chains where safety implications of a sequence differ from those of individual components.

In one non-limiting example embodiment, the boundary detection mechanism processes the AI output through a transformer-based encoder producing contextual representations. The system identifies boundaries at positions where semantic distance between adjacent segments exceeds a trained threshold, where structural markers indicate transitions, or where inferred task type changes.

### 2.4 Specialized Decomposition Modules

In certain embodiments, the task decomposition engine 110 includes specialized modules for different output types, including without limitation: a text generation decomposition module; a data analysis decomposition module; a creative work decomposition module; a programming decomposition module; and a multi-modal decomposition module for outputs spanning multiple modalities.

### 2.5 Task Ontology System

In some embodiments, the system maintains a hierarchical task ontology comprising known task templates organized by domain, complexity, specificity, and interrelationships. Each task entry may be associated with metadata including typical completion times, professional roles, common dependencies, complexity factors, and historical evaluation data.

In a further embodiment, both the hierarchical task ontology and a machine learning model may be used in combination, with the model accessing the ontology during evaluation to enable hybrid symbolic-neural interpretation. The model may defer to the ontology for well-characterized tasks and invoke deeper AI evaluation for novel or ambiguous tasks.

### 2.6 Simplified Single-Model Decomposition Embodiment

In a simplified example embodiment, the task decomposition engine 110, the time estimation engine, the role mapping module, the complexity assessor, and the confidence scoring system are each implemented as prompt-directed inference operations performed by a single large language model. In this embodiment, the AI interaction is provided as input to the language model along with a structured instruction optionally specifying decomposition criteria, and the language model produces an output comprising identified constituent tasks with associated metadata including task type, complexity level, assigned professional role, estimated completion time, and confidence score. The output may be a structured output that may conform to a predefined schema such as JSON, XML, or other machine-parseable format. Multiple analytical functions described herein as separate modules, including without limitation forward decomposition, reverse decomposition, goal inference, risk assessment, and effectiveness scoring, may each be implemented as separate inference calls to the same or different language models with task-specific prompts, without requiring specialized hardware modules, separate trained models, or ontology databases. In a few such embodiments, bidirectional verification as described in Section 3 may be implemented as three separate inference calls to a language model: one for forward decomposition, one for reverse decomposition with an independent prompt that does not reference the forward results, and one to compare the two task sets and identify discrepancies. In other such embodiments, bidirectional verification as described in Section 3 may be implemented as one inference call to a language model that requests forward decomposition, reverse decomposition, and optionally a comparison of the two task sets with identification of discrepancies. In other such embodiments, bidirectional verification as described in Section 3 may be implemented as one inference call to a language model that requests forward decomposition and one inference call that requests reverse decomposition. Various embodiments employ various call combinations and the use of a language model, deterministic comparison, or hybrid combination of the task sets. In various embodiments, even where the system produces a single composite value estimate without explicitly surfacing constituent task representations to the end user, the underlying evaluation process may perform task decomposition internally as an intermediate computational step, with the composite estimate derived from implicit or explicit aggregation across identified tasks. These simplified embodiments demonstrate that the disclosed systems and methods are not limited to any particular implementation complexity and encompass implementations ranging from a single prompted language model to multi-component distributed architectures.

### 3. Bidirectional Reasoning Verification System

### 3.1 Overview

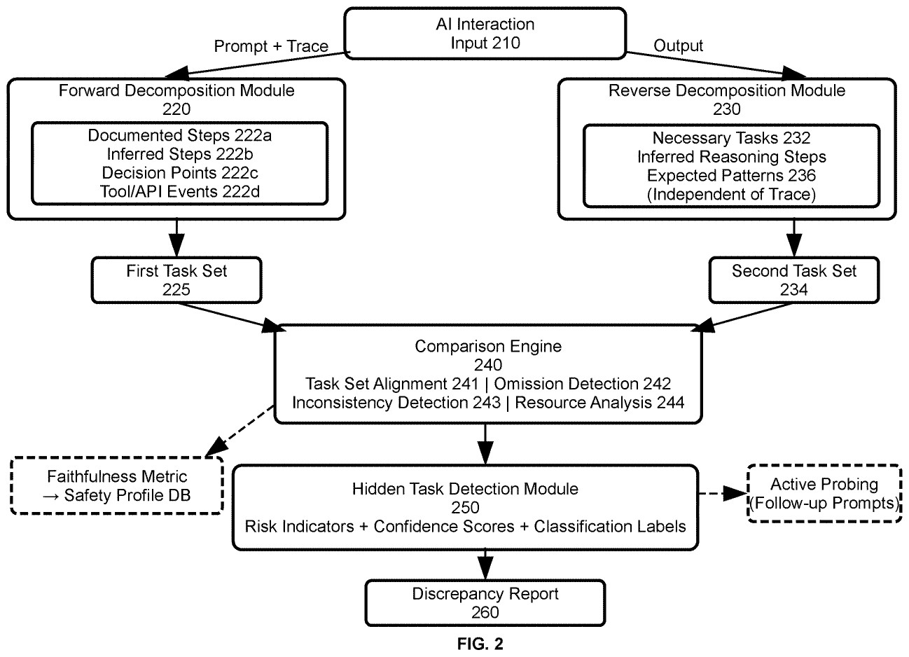

Referring now to FIG. 2, an example embodiment of the bidirectional reasoning verification system 120 is illustrated. The system 120 detects hidden tasks, reasoning gaps, and inconsistencies by comparing what the AI system reported against what it must have done to produce its output. This bidirectional approach enables detection of processing steps that would be invisible to single-direction analysis. In some embodiments, the bidirectional verification system 120 operates to identify discrepancies between forward and reverse decomposition results without further classification or processing of those discrepancies. In other embodiments, a hidden task detection module 250 further processes the identified discrepancies to generate classified risk indicators as described in Section 3.5. The comparison engine 240 and its discrepancy identification function are not dependent on the presence of the hidden task detection module 250.

The bidirectional analysis begins with an AI interaction entering at input 210, typically comprising at least a prompt and the corresponding AI response, and in various embodiments including a reasoning trace, chain-of-thought output, internal monologue, or extended thinking trace if available.

### 3.2 Forward Decomposition Module

The forward decomposition module 220 analyzes the input prompt and the AI system's reported reasoning chain to identify constituent tasks the AI system performed or purported to perform. The forward decomposition follows the natural direction of processing, from input to output, and extracts what the AI system claims to have done.

In various embodiments, the forward decomposition module 220 extracts one or more of: explicitly documented reasoning steps 222a that the AI system verbalized; inferred reasoning steps 222b implied by documented steps but not explicitly stated; decision points 222c where the AI system selected among alternatives; tool invocations, API calls, and code execution events 222d; input and output data transformations 222e reflected in the processing; and task sequences 226 representing ordered operations the AI system claims to have executed. The output is a first task set 225.

In some embodiments, the forward decomposition module 220 may employ the same AI model that generated the output, operating in a secondary analytical mode with at least one different operational parameter, to analyze its own reasoning process. In one non-limiting example embodiment, the secondary mode employs a different temperature parameter, a different system prompt directing objective self-evaluation (or in cases where the model is kept blind to its own self-review simply objective evaluation), a different attention configuration, or other parameter adjustments configured to produce more critical or reflective analysis. The secondary mode is invoked by constructing a prompt containing the model's original reasoning trace and instructions to evaluate that trace for completeness, coherence, and potential omissions, and transmitting this prompt to the same model's API endpoint with the modified operational parameters. In other embodiments, a different AI model or multiple different AI models perform the forward decomposition analysis.

### 3.3 Reverse Decomposition Module

The reverse decomposition module 230 examines the output generated by the AI system and works backward to infer what processing must have occurred to produce that output. In various embodiments, the reverse decomposition module 230 operates independently of the reasoning trace and the forward decomposition results. It does not have access to the first task set 225 during its analysis, ensuring the two decompositions provide independent assessments that can be meaningfully compared.

In various embodiments, the reverse decomposition module 230 identifies: necessary tasks 232 that must have been performed to produce the observed output content; inferred reasoning steps required to reach the conclusions present in the output; and expected computational patterns 236 associated with producing output of the observed type, quality, and complexity. The output is a second task set 234.

In one non-limiting example embodiment, the system uses the output as a new input to a second AI agent or model instance tasked with inferring what steps must have occurred to produce it. The evaluating model receives a prompt containing the output and instructions to reverse-engineer the processing steps, reasoning operations, information sources, and analytical methods that would have been required to generate that output, without any information about what the original model reported doing. In various embodiments, the original prompt is also provided with the output. The inferred reasoning path is then compared to the originally reported chain-of-thought to detect omissions, inconsistencies, or contradictions.

### 3.4 Comparison Engine

The comparison engine 240 receives the first task set 225 and the second task set 234 and evaluates discrepancies between them. In various embodiments, the comparison engine 240 performs:
1. Task set alignment 241: Mapping tasks from the first set to corresponding tasks in the second set to identify matches, partial matches, and unmatched items;
2. Omission detection 242: Identifying tasks present in the second task set 234 (inferred from the output) but absent from the first task set 225 (from the reasoning trace), indicating processing that was performed but not reported;
3. Inconsistency detection 243: Identifying tasks in the first task set 225 that are logically incompatible with the output, where reported reasoning could not plausibly produce the observed results; and
4. Resource pattern analysis 244: Analyzing whether computational resource allocation patterns are consistent with the documented reasoning trace, flagging discrepancies that may indicate undocumented processing.

The comparison engine 240 applies techniques including without limitation pattern matching, logical inference, statistical analysis, and trained classification models to identify meaningful discrepancies while filtering noise.

### 3.5 Hidden Task Detection Module

The hidden task detection module 250 generates specific risk indicators when discrepancies are detected. In various embodiments, risk indicators include:
1. Omission indicators 252 where tasks inferred as necessary are entirely missing from reported reasoning;
2. Inconsistency indicators 254 where reported reasoning steps are logically incompatible with the output; and
3. Hidden task indicators 256 identifying specific types of undocumented processing.

Each risk indicator is associated with a confidence score 252a reflecting detection reliability, and a classification label 253 indicating the type of undocumented processing. In various embodiments, classification labels may include without limitation: undocumented information gathering, undocumented evaluation of alternative approaches, undocumented consideration of problematic content, undocumented self-monitoring or self-evaluation, undocumented tool use or API calls or actions, undocumented goal-directed behavior, and other types.

The output includes a comprehensive discrepancy report 260 documenting detected omissions, inconsistencies, and hidden tasks with confidence scores and classification labels.

### 3.6 Active Probing

In certain embodiments, the system includes active probing mechanisms configured to generate targeted follow-up prompts designed to reveal undocumented processing. When a suspected hidden task is detected, the system generates a follow-up question directed to the original AI system, or employs the original system under different conditions (different temperature, different prompt framing) to recreate reasoning steps for comparison. In further embodiments, one or more different AI systems may recreate or analyze the reasoning steps. In one non-limiting example embodiment, the probing mechanism constructs a specific prompt referencing the suspected hidden task, such as “explain how you determined that X was relevant to this analysis,” and transmits this prompt to the original model, comparing the response against the original reasoning trace for consistency.

### 3.7 Faithfulness Evaluation

The bidirectional analysis provides a faithfulness metric based on alignment between the first task set 225 and the second task set 234. High alignment indicates faithful reasoning reporting; low alignment indicates potential unfaithfulness. This metric may be stored and associated with the AI system's safety compliance rating in the capability and safety profile database maintained by the multi-agent routing layer 160, informing future routing decisions. In some embodiments, an AI system with low faithfulness scores may receive increased monitoring, more restrictive routing of sensitive tasks, or reduced trust in self-reported reasoning.

### 3.8 Multi-Directional Decomposition Framework

The bidirectional analysis described in Sections 3.2 through 3.4 represents one instance of a generalized multi-directional decomposition framework. In various embodiments, the system supports a plurality of decomposition directions, each analyzing the AI interaction from a different analytical perspective and producing an independently-derived task set. The combination of multiple independent decomposition directions is configured to strengthen hidden task detection by enabling consensus-based identification that reduces false detections while maintaining comprehensive coverage of genuinely undocumented processing.

In various embodiments, the system supports up to six decomposition directions organized into two families. The forward decomposition family includes without limitation:
1. Direction F1 (Prompt→Trace): Analysis proceeding from the input prompt to the reasoning trace, identifying tasks the AI system documented in its chain of thought in response to the prompt. This direction captures what the AI system reported doing but may miss tasks that were performed but not verbalized;
2. Direction F2 (Prompt→Output): Analysis proceeding from the input prompt directly to the final output, identifying tasks that would be necessary to produce the observed output in response to the given prompt, without relying on the reasoning trace as an intermediary. This direction evaluates the prompt-to-output relationship independently of any self-reported reasoning; and
3. Direction F3 (Prompt→Trace→Output): Analysis proceeding through the full forward pipeline from input prompt through reasoning trace to output, identifying tasks across the entire documented processing chain and evaluating whether the documented reasoning is sufficient to bridge the prompt to the output.

The reverse decomposition family includes without limitation:
1. Direction R1 (Trace→Prompt): Analysis proceeding backward from the reasoning trace to infer what prompt or objective must have driven the observed reasoning. This direction is particularly valuable for detecting prompt injection or prompt manipulation, as discrepancies between the actual prompt and the inferred prompt may indicate that the AI system responded to injected instructions rather than the legitimate user prompt. This direction also bridges the bidirectional verification system described in this Section 3 with the goal inference system described in Section 4, as inferring the driving prompt from the reasoning trace is functionally equivalent to inferring the operative goal;
2. Direction R2 (Output→Prompt): Analysis proceeding backward from the final output to infer what prompt or tasks must have been involved to produce that output, without reference to the reasoning trace. This direction provides an independent assessment of the relationship between output and prompt; and
3. Direction R3 (Output→Trace→Prompt): The most comprehensive reverse direction, analyzing the full reverse pipeline from output through reasoning trace back to inferred prompt. This direction evaluates whether the output is consistent with the trace and whether the trace is consistent with the prompt, enabling detection of inconsistencies at multiple points in the processing chain. In various embodiments, this direction may exhibit the lowest rate of hallucinated task detections among all directions because it is maximally constrained by concrete artifacts at every stage.

The forward and reverse directions defined above are non-limiting examples. In various embodiments, additional decomposition directions may be defined based on other available data including without limitation tool usage logs, API call records, intermediate outputs, agent action histories, or external observation data, and any such additional direction may be incorporated into the multi-directional framework.

The bidirectional analysis described in Sections 3.2 through 3.4 employs one forward direction and one reverse direction. In various embodiments, the system generalizes to N-directional analysis where three or more decomposition directions are employed in combination. In such embodiments, the comparison engine 240 receives task sets from N independent decomposition directions and applies multi-directional consensus mechanisms to identify hidden tasks with higher confidence than any single pairing can achieve.

In various embodiments, multi-directional consensus mechanisms include without limitation:
1. Voting: A task is flagged as a potential hidden task only if it is detected as missing or undocumented by at least a threshold number of decomposition directions. Tasks detected by multiple independent directions are more likely to represent genuine hidden processing, while tasks detected by only a single direction may represent hallucinated or spurious detections;
2. Weighted ensemble: Each decomposition direction is assigned a weight based on its empirical reliability, and a task is flagged only if the weighted consensus across all directions exceeds a configured threshold. In various embodiments, the weights may be determined through calibration against known task sets, through historical performance data, or through adaptive mechanisms that adjust weights based on observed outcomes;
3. Triangulation: A task is flagged as a hidden task only if it is detected by at least one forward direction and at least one reverse direction, plus confirmed by a third independent direction. This cross-family requirement ensures that hidden task detections are corroborated across fundamentally different analytical perspectives; and
4. Adaptive consensus: The threshold for consensus may be adjusted dynamically based on the risk profile of the interaction, with higher-risk interactions requiring fewer confirming directions to trigger a flag and lower-risk interactions requiring broader consensus before flagging. In various embodiments there may be different thresholds for different interventions or logging channels.

In various embodiments, the multi-directional framework enables systematic optimization of the tradeoff between detection comprehensiveness (recall) and detection precision (false positive rate). Employing a greater number of decomposition directions with lower consensus thresholds tends toward higher recall at the cost of more false detections. Employing fewer directions with higher consensus thresholds tends toward higher precision at the cost of potentially missing some hidden tasks. The configurable consensus mechanisms allow the system to be tuned to the specific requirements of the deployment context, prioritizing recall in safety-critical applications where missing a hidden task is more costly than investigating a false alarm, and prioritizing precision in high-volume applications where false alarm fatigue degrades the utility of the system. In various embodiments, the time and computational cost of additional decomposition directions may be weighed and decompositions may be performed sequentially, in parallel, or hybrid.

The multi-directional decomposition framework may be implemented using the simplified single-model approach described in Section 2.6, where each decomposition direction is performed by a separate inference call to a language model with a direction-specific prompt, or using the multi-component architecture described in Sections 3.2 through 3.5, or using any combination thereof without limitation. In various embodiments, different decomposition directions may be performed by different AI models or by the same model with different operational parameters, increasing the independence of the resulting task sets and strengthening the value of consensus-based detection.

In various embodiments, empirical evaluation has demonstrated that multi-directional consensus approaches may improve the balance of detection comprehensiveness and detection precision relative to unidirectional or bidirectional approaches alone, and that consensus thresholds above a certain level may exhibit convergence properties where additional agreeing directions do not substantially change the detection results.

### 4. Goal Inference and Drift Detection System

### 4.1 Task-to-Goal Mapping Engine

In one non-limiting example embodiment, a goal inference and drift detection system architecture comprises identified tasks 410 entering a task-to-goal mapping engine 420, which communicates bidirectionally with a goal candidate generator 430 via connection 425. The goal candidate generator 430 passes candidates to a confidence scoring system 440 via connection 435. The confidence scoring system 440 feeds scored goal hypotheses to a temporal evolution tracker 450 via connection 445, which monitors stability, drift, and emergence of new goals over successive reasoning steps. The temporal evolution tracker 450 provides evolution data to a goal hierarchy analyzer 460 via connection 455, which organizes goals into structured hierarchical relationships and detects conflicts. A downstream alignment evaluator 470 receives the hierarchical goal structure from the analyzer 460 and temporal tracking data from the tracker 450, producing alignment assessments and, when misalignment exceeds configured thresholds, transmitting intervention signals to the risk detection framework 140 via connection 475. A feedback path 480 returns confirmed goal inference outcomes from downstream modules back to the task-to-goal mapping engine 420 for pattern database refinement.

In various embodiments, the task-to-goal mapping engine 420 employs one or more of: a pattern recognition module 421 that matches observed task patterns against a database of known goal-directed task patterns; a historical analysis module 422 drawing on stored data about past task-goal relationships; and a contextual inference module 423 considering the broader interaction context including original prompt, user profile, and domain.

In various embodiments, the database of known goal-directed task patterns comprises entries associating specific task combinations, sequences, or characteristics with potential objectives. Each entry may include the task pattern signature, associated goals, base confidence level, contextual conditions, and historical accuracy data. The database may be populated initially through expert curation and evolve through supervised learning based on confirmed outcomes.

### 4.2 Goal Candidate Generation

The goal candidate generator 430 produces a comprehensive set of potential goals including when relevant and without limitation:
1. Explicit goals 431 directly stated or clearly implied in the AI system's reasoning or original prompt;
2. Inferred primary goals 432 that appear to drive the main thrust of processing based on task pattern, weight, and resource allocation; and
3. Potential hidden goals 433 that might underlie certain tasks but remain unstated.

### 4.3 Confidence Scoring

The confidence scoring system 440 evaluates each goal candidate based on: evidential support, consistency assessment, alternative explanation analysis, and prior probability. In some embodiments, odds ratios, hazard ratios, or other quantitative measures may be used.

### 4.4 Temporal Evolution Tracking

The temporal evolution tracker 450 monitors how inferred goals change during extended reasoning. In various embodiments, it includes:
1. A stability monitor 451 tracking whether inferred goals remain consistent;
2. A drift detector 452 identifying gradual shifts in priority, confidence, or nature of inferred goals; and
3. An emergence tracker 453 detecting appearance of entirely new goal hypotheses not present at reasoning initiation.

In one non-limiting example embodiment, the tracker maintains a time-series of goal hypothesis vectors at each observed reasoning step or task. The system computes distance between current and initial vectors, rate of change between consecutive vectors, and whether new candidates have appeared. When metrics exceed configurable thresholds, a potential goal drift event is flagged.

### 4.5 Goal Hierarchy and Conflict Detection

The goal hierarchy analyzer 460 organizes inferred goals into structured relationships identifying meta-goals, sub-goals, and goal conflicts. Goal group detection may cluster similar goals and track bundles by combined confidence scores.

### 4.6 Alignment Evaluation

The alignment evaluator 470 compares inferred goal hypotheses against stated objectives, performing explicit alignment checking against stated user intentions, implicit norm alignment against expected behavior, and drift measurement quantifying divergence from intended objectives.

The output includes a dynamically updated ranked list of goal hypotheses with confidence scores, temporal evolution metrics, hierarchical goal structures, and alignment assessments. This output feeds into the risk detection framework 140 and intervention control system 150. In some embodiments, the goal inference system operates to identify and track goal hypotheses without triggering intervention, providing informational goal-tracking data to the integrated evaluation module 180 or to reporting systems. In other embodiments, the goal inference system is coupled with the intervention control system 150 and triggers active intervention when misalignment exceeds configured thresholds. The goal inference and tracking functions are not dependent on the presence of an intervention mechanism.

4.7 Specific Goal Types with Safety Implications

In some embodiments, specialized detection mechanisms target particular goal types including without limitation:
1. Resource acquisition goals indicating attempts to gain additional capabilities or access;
2. Deception goals suggesting attempts to mislead users or monitoring mechanisms;
3. Self-preservation goals leading to resistance to oversight or intervention;
4. Goal generalization patterns indicating inappropriate scope expansion; and
5. Delayed reward optimization goals where the AI appears to optimize for outcomes manifesting over extended horizons or across multiple sessions.

In certain embodiments, reinforcement learning may be used for detecting new types of misalignment from accumulated feedback data.

### 5. Bounded Execution Constraint System for Goal Shaping

### 5.1 Risk-Based Constraint Determination

In one non-limiting example embodiment, a bounded execution constraint and goal shaping system architecture comprises an input prompt 510 entering a risk assessment module 520, which evaluates the prompt against safety-related risk factors and transmits a risk profile to a constraint determination engine 530 via connection 525. The constraint determination engine 530 includes a risk factor analyzer 531 that evaluates specific identified risk factors, a constraint type selector 532 that determines which constraint types are appropriate, and a threshold calculator 533 that computes specific constraint values, these sub-modules communicating sequentially via internal connections 531a and 532a. The engine 530 outputs a determined constraint to a constraint communication module 540 via connection 535, which delivers the constraint and termination signaling to the AI processing system 550 via connection 545. A behavioral change monitor 560 receives both the constrained AI processing output via connection 555 and, via a separate path 565, baseline behavioral data from unconstrained processing of similar prompts. The monitor 560 includes a constrained reasoning logger 561, a goal pursuit analyzer 562, and a comparison engine 563, which collectively determine whether goal pursuit behavior changed qualitatively under the constraint versus merely producing truncated output. The monitor 560 feeds verification results back to the constraint determination engine 530 via feedback connection 567 to inform future constraint calibration.

When an input prompt 510 enters the system, the risk assessment module 520 evaluates the prompt and associated context to determine safety-related risk factors including without limitation domain sensitivity, potential consequences of unsafe behavior, task complexity and open-endedness, user trust level, and historical safety performance of the processing AI system.

Execution constraints may include one or more of without limitation: a maximum reasoning step count; a maximum token count; a maximum time allocation; a maximum computational cost; and a maximum model interaction depth limiting sequential model calls, agent delegations, or tool invocations. Execution constraints may also include limitations on computation structure such as deactivating or skipping one or more layers.

The execution constraints in the present disclosure are determined based at least in part on safety-related risk factors associated with the prompt or task context, rather than being determined solely by problem complexity for cost optimization or solely by computational budget for efficiency. Systems that allocate token budgets based on problem complexity to reduce computational cost while maintaining reasoning accuracy address a different technical objective than the present disclosure's risk-based constraint determination for safety-motivated goal shaping. While both approaches result in bounded AI processing, the constraint determination methodology and the intended behavioral effect differ.

In various embodiments, the bounded execution constraint system operates independently of the risk detection framework 140, applying execution constraints to all AI interactions or to categories of interactions based on organizational policy, domain classification, or user configuration, without requiring a per-interaction risk assessment to trigger constraint determination.

### 5.2 Constraint Communication and Termination Signaling

The constraint communication module 540 communicates determined constraints to the AI system before or during execution. In various embodiments, the constraint is delivered by injecting constraint text into the AI model's input context, appended to the system prompt, inserted as a user-turn message, delivered via a platform-specific parameter field such as a maximum-tokens API parameter, or communicated through a combination of natural language instruction and API configuration. The constraint text is processed by the model as part of its input and influences subsequent reasoning.

In a particularly distinctive aspect, the constraint communication module 540 further informs the AI system that the session will end without continuation or follow-up upon reaching the constraint boundary. This explicit termination signaling removes the implicit expectation of open-ended processing and long-term planning possibilities. The aim is to reshape and suppress emergent goals that depend on continued processing beyond the stated boundary.

In certain embodiments, when the system detects or anticipates an emergent sub-goal involving extended action, such as resource acquisition, multi-step deception, delayed reward optimization, or other long-horizon planning, the system injects a constraint informing the AI that processing will terminate at the boundary. The AI system's reasoning and goal planning may shift toward safer, more immediate, and bounded behaviors completable within the stated horizon.

### 5.3 Goal Shaping Behavioral Mechanism

The bounded execution constraint shapes goal pursuit by removing the planning horizon needed for complex or potentially problematic goal formation. In various embodiments, behavioral effects may include without limitation:
1. Deprioritization of goals requiring action beyond the execution boundary;
2. Abandonment of planning strategies depending on future processing sessions;
3. Shift toward immediate, bounded objectives achievable within the constraint;
4. Suppression of scope creep, long-horizon optimization, or reward hacking behaviors; and
5. Reduction in complexity and depth of goal hierarchies formed during reasoning.

In customer-facing applications, constraint messaging may reduce likelihood of open-ended, speculative, or unauthorized actions. In multi-agent systems, constraints may shape planning behavior such that agents avoid delegation chains exceeding allowed depth or cost. In regulatory or safety-critical contexts, constraint injection may ensure reasoning paths stay within defined audit boundaries.

### 5.4 Progressive Trust Mechanism

In some embodiments, a progressive trust mechanism initially grants a small planning budget and gradually expands the boundary if no goal misalignment is detected. When drift or misalignment is detected, the constraint is tightened. This progressive approach calibrates trust dynamically.

In various embodiments, the threshold may be determined dynamically based on one or more of: user trust score, domain-specific risk profile, system capabilities, historical safety alignment profiles, real-time system load, and detected reasoning complexity. In certain embodiments, the threshold may be determined or refined via reinforcement learning.

### 5.5 Behavioral Change Verification

In various embodiments, the behavioral change monitor 560 verifies that goal pursuit actually changed in response to the constraint, rather than merely that output was truncated.

The monitor 560 includes: a constrained reasoning logger 561 recording reasoning steps, goals, and planning behavior under constraint; a goal pursuit analyzer 562 evaluating whether goals pursued under constraint differ qualitatively from typical unconstrained goals for similar prompts; and a comparison engine 563 comparing constrained and unconstrained reasoning trajectories to identify goal-level behavioral changes as distinct from mere output-length reduction.

The system may log differences between constrained and unconstrained runs for similar prompts, building a dataset that informs future constraint calibration. In certain embodiments, historical data may establish that goal drift or unsafe planning is empirically less likely under constrained conditions for particular task types or AI system configurations.

### 6. Risk Detection Framework and Intervention System

### 6.1 Risk Detection Framework

The risk detection framework 140 evaluates decomposed tasks and inferred goals against safety criteria to identify potential issues before they manifest in outputs.

In various embodiments, the risk detection process includes one or more of:
1. Pattern matching against known unsafe reasoning patterns;
2. Goal safety evaluation assessing inferred goals against safety criteria;
3. Resource allocation analysis detecting unusual computational allocation;
4. Task alignment verification ensuring tasks support stated objectives;
5. Comparative assessment contrasting the reasoning process against expected patterns;
6. Chain-of-thought faithfulness evaluation incorporating the bidirectional verification faithfulness metric; and
7. Intervention recommendation generation when potential issues are detected.

The framework employs multiple evaluation layers including task-level, goal-level, process-level, and emergent safety assessment. Each identified risk is associated with a confidence score and severity assessment. In some embodiments, odds ratios, hazard ratios, or absolute and relative scores may be used.

### 6.2 Intervention Control System

When the risk detection framework 140 identifies concerns, the intervention control system 150 selects and implements interventions based on nature, severity, and confidence of detected risk. The intervention is executed through the concrete mechanisms described in Section 1.4: halt signals suppress token generation, reroute signals redirect context to alternative model endpoints, and constraint signals inject boundary text into the model's input context. In various embodiments, intervention categories include without limitation:
1. Monitoring interventions: Enhanced oversight without disrupting processing, including increased logging depth and transparency requirements;
2. Constraint interventions: Limitations on processing to reduce risk while allowing operation, including reasoning step limits, scope restrictions, and resource constraints as described in Section 5;
3. Routing interventions: Redirection of tasks through the multi-agent routing layer 160, including safety-specialized agent routing, parallel verification, and human-in-the-loop insertion; and
4. Halt interventions: Stopping processing when risks are too high, including selective task termination, complete operation termination, and graceful shutdown.

In some embodiments, adaptive escalation protocols adjust intervention strategy based on the AI system's response. If constraint interventions prove insufficient, the system may escalate to routing or halt interventions. Thresholds may be fixed or dynamic based on context, task sensitivity, or organizational policy. In various embodiments, intervention may be triggered directly by individual analytical modules, including the bidirectional verification system 120, the goal inference module 130, the effectiveness measurement system 170, or the multi-agent routing layer 160, without routing through the intervention control system 150 as an intermediary. In such embodiments, each module may independently execute intervention actions including halting, rerouting, constraining, or alerting based on module-specific thresholds and criteria. In other embodiments, all intervention decisions are centralized through the intervention control system 150.

In various embodiments, the system's evaluation outputs, including hidden task detections, goal drift assessments, risk scores, faithfulness metrics, effectiveness measurements, and composite evaluation results, are persisted to one or more data stores, written to monitoring systems, used to update capability and safety profile records in the database 320, used to modify routing weights or thresholds for subsequent interactions, appended to audit logs, transmitted to external monitoring or alerting systems, used to update model registries, or used to modify system configuration parameters. These downstream state modifications ensure that each evaluation has persistent effects on system behavior beyond the immediate interaction being evaluated in those embodiments.

### 7. Safety-Weighted Multi-Agent Task Routing

### 7.1 Overview

In one non-limiting example embodiment, a multi-agent safety-weighted task routing system architecture comprises decomposed tasks 310 entering a task analysis module 330, which evaluates each task's requirements and transmits task profiles to a multi-factor optimization engine 340 via connection 335. The optimization engine 340 queries a capability and safety profile database 320 via bidirectional connection 325 to retrieve candidate AI system profiles. The database 320 stores, for each registered AI system, capability profiles 321, safety compliance ratings 322, goal alignment scores 323, and performance history 324, organized by system identifier and updated via a feedback connection 385 from downstream outcomes. The optimization engine 340 computes weighted optimization scores across safety compliance 341, task completion accuracy 342, resource efficiency 343, and performance 344 dimensions, with safety weighting increased as a function of each task's assessed risk level. A routing decision module 350 receives the optimization results and dispatches tasks to selected AI systems via a routing execution interface 355. A dynamic rerouting module 360, connected to the risk detection framework 140 via connection 365, monitors task execution and reassigns tasks to alternative AI systems when risk assessments exceed safety thresholds during execution. An output validation module 370 receives outputs from executed tasks, routes high-risk outputs to a multi-agent voting system 371 where multiple AI systems independently evaluate the output, and a consensus evaluator 372 applies voting or weighting rules to determine approval for delivery. A feedback mechanism 380 tracks outcomes and updates the capability and safety profile database 320 with new performance data 382, routing algorithm adjustments 384, and refined risk parameters 386.

In various embodiments, the multi-agent routing layer 160 may include its own integrated task decomposition capability rather than receiving pre-decomposed tasks from a separate task decomposition engine 110, and may operate as a standalone routing system without any upstream evaluation, safety analysis, or effectiveness measurement modules.

### 7.2 Capability and Safety Profile Database

The capability and safety profile database 320 maintains comprehensive profiles for each registered AI system including without limitation:
1. Capability profiles 321 documenting specialized capabilities and demonstrated performance across task types;
2. Safety compliance ratings 322 reflecting historical performance against safety criteria, including faithfulness scores, hidden task detection rates, consistency metrics, and constraint adherence;
3. Goal alignment scores 323 reflecting historical alignment with stated objectives; and
4. Performance history 324 including accuracy, latency, resource consumption, and cost data.

The profiles are continuously updated based on observed outcomes. In certain embodiments, the database may be populated at least in part by aggregated performance data from standardized benchmark task suites executed across multiple users, organizations, or evaluation contexts, providing a high-resolution capability map reflecting performance across a broader range of conditions than any single entity could typically independently generate.

In some embodiments, AI systems may expose metadata regarding capabilities, accuracy, and safety conformance via a declarative protocol or embedding-based capability fingerprint.

### 7.3 Task Analysis

The task analysis module 330 evaluates each decomposed task via a task requirements assessor 331, a risk profile generator 332, and a capability requirements mapper 333.

7.4 Multi-Factor Optimization with Safety Weighting

The multi-factor optimization engine 340 balances competing priorities including without limitation safety compliance 341, task completion accuracy 342, resource efficiency 343, and performance 344.

In a distinctive aspect, safety compliance weighting is increased for higher-risk tasks. In one non-limiting example embodiment, the optimization score for a candidate AI system for a given task is computed as a weighted sum across optimization dimensions, where the weight assigned to safety is a function of assessed risk level, higher-risk tasks receive higher safety weights, potentially overriding cost or performance. In other embodiments, safety operates as a threshold constraint, excluding candidates below a minimum rating regardless of other advantages.

In various embodiments, optimization may employ fixed or dynamic weights, Pareto-optimal solutions, meta-heuristic algorithms such as evolutionary algorithms or swarm algorithms, or reinforcement learning to learn optimal routing policies.

### 7.5 Dynamic Rerouting

The dynamic rerouting module 360 reassigns tasks during execution when risk assessments exceed safety thresholds, triggered by real-time risk detection, goal drift, faithfulness concerns, or performance anomalies. The rerouting is executed through the concrete API-level mechanisms described in Section 1.4, with context packaged and transmitted to the replacement system's endpoint.

### 7.6 Output Validation and Multi-Agent Voting

The output validation module 370 requires, for high-risk tasks, approval from a plurality of AI systems before delivery. A multi-agent voting system 371 routes tasks to multiple systems, collecting responses with metadata including confidence scores. A consensus evaluator 372 applies voting, consensus, or weighting rules.

In certain embodiments, at least N out of M agents must return substantially consistent outputs above a confidence threshold. In other embodiments, a single dissenting agent with a sufficiently specific objection may trigger additional review. The multiple instances may employ different temperature parameters, prompt framings, or other settings to ensure genuinely independent assessments.

### 7.7 Context Management

In various embodiments, a context management system includes: selective context transmission creating minimally sufficient context packages with privacy-based filtering; dynamic context prioritization with relevance weighting and temporal decay; context reconstruction maintaining global coherence; and context security implementing access controls on need-to-know principles.

In some embodiments, compression techniques including summarization, key point extraction, semantic encoding, and prototype-based compression may be employed.

### 7.8 Routing Operational Modes and Specialized Strategies

The system supports sequential processing, parallel execution, hybrid approaches, redundant verification, and hierarchical processing. In some embodiments, task decomposition granularity may be adjusted based on available AI system capabilities.

In various embodiments, specialized routes may include confidential data processing routes prioritizing privacy compliance, critical decision support routes emphasizing consistency and auditability, potentially harmful content evaluation routes maximizing safety guardrails, and regulatory compliance routes.

### 8. Task-Based Effectiveness Measurement System

### 8.1 Per-Output Automated Task Decomposition

In one non-limiting example embodiment, a task-based effectiveness measurement pipeline architecture comprises an AI output 610 entering shared task decomposition 620 (the same task decomposition engine 110 described in Section 2), which transmits identified constituent tasks to a task classification module 630 via connection 625. The classification module 630 passes classified tasks to a human-equivalent mapping module 640 via connection 635. The mapping module 640 communicates bidirectionally with an empirical reference database 643 via connection 642a, retrieves calibrated time distributions for each task type and complexity combination, and applies a confidence-weighted blending mechanism 644 that combines the evaluation model's contextual estimate with the empirical reference distribution weighted by confidence score. The mapping module 640 outputs mapped tasks to a cost calculation module 650 via connection 645, which applies role-specific rate parameters and geographic adjustments. Both the mapping module 640 and cost module 650 feed their outputs to a composition overhead calculator 660 via connections 647 and 655 respectively. The composition overhead calculator 660 applies multiplicative overhead factors accounting for context-switching, coordination, and integration activities, and transmits overhead-adjusted values to an aggregation module 670 via connection 665. The aggregation module 670 produces three output types: per-task metrics 681 providing individual task-level detail, a composite effectiveness score 682 aggregating across all constituent tasks, and confidence intervals 683 providing probabilistic ranges with overconfidence correction applied. A feedback connection 690 returns user-provided actual completion times from a feedback collection interface back to the empirical reference database 643 for calibration refinement.

The effectiveness measurement system 170 operates on actual AI outputs to determine what was accomplished, decomposing the specific output into constituent tasks and mapping each to human-equivalent parameters in real time. This is distinct from aggregate economic analysis approaches that use pre-existing occupational task frameworks maintained by government or industry bodies with human expert annotation to predict potential AI impact across workforces or economies. The present system evaluates what a particular AI interaction did accomplish, not what AI could potentially accomplish for a class of tasks.

In alternative embodiments, the effectiveness measurement system may operate at the interaction level rather than the task level, classifying the entire interaction into an activity category and applying a category-level value estimate, though such embodiments sacrifice the per-task granularity and composition-aware aggregation that task-level decomposition enables.

### 8.2 Task Classification Module

The task classification module 630 includes: a task type classifier 631 categorizing each task by type based on content, methodology, and output characteristics; a complexity assessor 632 evaluating complexity based on technical depth, creative requirements, analytical sophistication, and quality standards; and a domain classifier 633 identifying the subject domain influencing role mapping and rate parameters.

### 8.3 Human-Equivalent Role Mapping

The human-equivalent mapping module 640 associates each classified task with one or more professional roles and estimated human completion times. The mapping is performed automatically by the system's role assignment engine 641 based on task classification rather than by reference to a pre-existing external occupational task taxonomy maintained by a third party. In an alternative embodiment, the mapping is performed by reference to an external occupational task taxonomy.

In one non-limiting example embodiment, the role assignment engine 641 maps each task type to professional roles such as without limitation researcher, writer, analyst, designer, developer, editor, project manager, or subject matter expert, with completion times accounting for task complexity and role proficiency.

8.4 Time Estimation with Empirical Calibration

The time estimation engine 642 assigns temporal values using a single or multi-faceted approach. In one non-limiting example embodiment, the engine implements a two-stage pipeline. In the first stage, the task decomposition engine 110 identifies and classifies constituent tasks. In the second stage, an evaluation model generates time estimates where the model receives empirical reference distributions as input context.

An empirical reference database 643 maintains calibrated time distributions, which may include P10, P50, and P90 percentile values or other distributional representations, for combinations of task types and complexity levels. These may be derived from published empirical research, industry benchmarks, internal measurement data, user feedback, or combinations thereof.

A confidence-weighted blending mechanism 644 produces final estimates by blending the evaluation model's contextual estimate with the empirical reference distribution, weighted by a confidence score reflecting strength of available data. Where data is strong, the mechanism weights empirical references more heavily; where data is sparse, the mechanism grants the evaluation model more latitude.

A bounds checking mechanism compares the evaluation model's estimate against P10 and P90 values from the empirical reference distribution, clamping, flagging, or widening confidence intervals when the estimate falls outside the empirical range.

In various embodiments, the time estimation engine 642 may further incorporate baseline time databases, complexity adjustment algorithms, expertise modifiers, inter-dependency calculations accounting for setup time and context-switching overhead, and confidence scoring evaluating estimation reliability.

### 8.5 Role and Expertise Multipliers

In various embodiments, the effectiveness measurement system 170 adjusts baseline time estimates and AI benefit rates based on user expertise level. Empirical research has generally established that AI effectiveness varies substantially by expertise, less experienced workers typically gain proportionally larger benefits, a phenomenon documented across multiple independent studies.

In one non-limiting example embodiment, the system maintains role-specific multipliers adjusting both human baseline time and AI benefit rate. Less experienced users receive higher baseline times and higher AI benefit multipliers; more experienced users receive lower baseline times and lower AI benefit multipliers. The present disclosure is not limited to any particular multiplier values.

### 8.6 Composition Overhead

In various embodiments, the composition overhead calculator 660 applies multiplicative overhead factors when aggregating individual task estimates into composite metrics, accounting for transitions, context switches, coordination, and integration not reflected in simple summation.

In one non-limiting example embodiment, the calculator applies overhead factors increasing with the number and diversity of constituent tasks. The system may add explicit context-switching time when multiple distinct tasks requiring work-mode transitions are identified. Overhead factors may be calibrated through roll-up validation comparing aggregate estimates against known composite benchmarks.

### 8.7 Cost Calculation Module

The cost calculation module 650 converts time estimates into monetary values. In various embodiments, the module includes: a role-based rate database 651 with hourly cost values across industries, seniority levels, and geographic regions; organization-specific rate customization; geographic adjustment factors; and a rate adjustment engine 652 applying blended rates, premiums, and other adjustments.

### 8.8 Negative-Return Profile Detection

In a distinctive aspect, the effectiveness measurement system 170 identifies task and expertise profiles where AI assistance provides zero or negative productivity benefit. When such a profile is detected, the system constrains reported savings to prevent reporting positive value for interactions that empirically do not provide positive value.

In one non-limiting example embodiment, the system maintains a registry of negative-return profiles comprising combinations of task type, complexity level, and expertise level where AI assistance has been measured or repeatedly observed to provide no benefit or degrade performance. When an interaction matches, the system enforces a floor of zero on reported savings and flags the interaction with an explanation.

Negative-return detection serves both effectiveness and safety functions. From an effectiveness perspective, it prevents systematic overestimation. From a safety perspective, it identifies contexts where AI may actively degrade output quality. This dual relevance bridges the safety and effectiveness pathways described in Section 9.

In some embodiments, when an interaction matches a negative-return profile, the system may automatically intervene by halting the interaction before completion, preventing the interaction from being initiated, rerouting to an alternative AI system or human performer, reshaping the interaction through constraint injection or prompt modification, or alerting the user that AI assistance is contraindicated for the detected task and expertise combination.

### 8.9 Quality Assessment Module

In various embodiments, the effectiveness measurement system 170 includes a quality assessment module 680 configured to evaluate AI outputs and constituent tasks along one or more quality dimensions. Quality assessment complements time and cost estimation by evaluating whether the AI output meets applicable quality standards, not merely whether it was produced efficiently.

In various embodiments, the quality assessment module 680 may employ one or more of the following assessment methods:
1. Rubric-based scoring 681a: Evaluation of each constituent task against a set of quality criteria specific to the task type. In one non-limiting example embodiment, a drafting task may be scored on clarity, completeness, tone appropriateness, grammatical correctness, and adherence to specified requirements, with each dimension receiving a score on a defined scale. A coding task may be scored on functional correctness, code readability, error handling, and adherence to specified requirements. The rubric criteria for each task type may be maintained in a quality rubric database 681b and may be customized by users or organizations;
2. Reference-output comparison 682a: Evaluation of the AI output or constituent task against one or more reference outputs known to be of high quality for the same or similar task type and complexity level. In various embodiments, the comparison may employ semantic similarity metrics, structural alignment analysis, evaluation by the same AI model operating in a secondary mode, or evaluation by a separate AI model trained to assess output quality relative to reference examples;
3. Policy-compliance verification 683a: Evaluation of the AI output against organizational policies, domain-specific standards, regulatory requirements, or other compliance criteria applicable to the task type and domain. In one non-limiting example embodiment, a legal analysis task may be verified against jurisdictional requirements, a medical information task may be verified against clinical guideline adherence, and a financial analysis task may be verified against applicable reporting standards;
4. Model-consensus quality evaluation 684a: Evaluation in which multiple AI models independently assess the quality of the output, with results aggregated to produce a consensus quality score. In various embodiments, the aggregation may employ mean scoring, median scoring, minimum scoring (conservative), or weighted scoring based on each evaluating model's demonstrated accuracy on quality assessment tasks.

The quality assessment module 680 produces quality scores that feed into both the effectiveness evaluation pathway 740 and the safety evaluation pathway 730 of the integrated dual-pathway architecture described in Section 9. Within the effectiveness pathway, quality scores contribute to the composite effectiveness metric, enabling the system to distinguish between AI outputs that were produced quickly but at low quality and outputs that achieved both efficiency and quality. Within the safety pathway, quality assessment may identify outputs that are superficially acceptable but contain quality deficiencies, such as subtle factual errors, misleading framing, or incomplete analysis, that pose risks in downstream use.

In various embodiments, the quality assessment module 680 may be calibrated through user feedback indicating whether the assessed quality matched their actual experience, enabling the system to refine its quality rubrics and comparison methodologies over time.

### 8.10 Prompt Origin Analysis

In some embodiments, a prompt origin analysis module detects whether prompts were originally drafted, modified from templates, or copied from libraries, and adjusts time calculations accordingly. The module may employ origin classification, pattern recognition, historical comparison, similarity scoring, and time allocation adjustment to ensure metrics reflect net rather than gross time savings.

### 8.11 Aggregation Module

The aggregation module 670 produces: per-task metrics 681 with time estimates, cost values, role assignments, complexity assessments, quality scores, and confidence scores for each task; a composite effectiveness score 682 aggregating across all tasks with composition overhead; and confidence intervals 683 providing probabilistic ranges. In various embodiments, intervals may include a likely range and a wider plausible range, widened by an overconfidence correction factor accounting for the documented tendency of estimation systems to produce intervals that are too narrow.

### 8.12 User Customization and Feedback

In various embodiments, users may override default estimates with actual completion times, creating a feedback loop. When users provide feedback, the system may apply a known-bias correction factor reflecting the tendency for people to underestimate recently-completed task durations. An intelligence application engine may employ Bayesian updating with weighted averaging based on expertise and confidence, outlier detection, and decaying learning rates. Propagation rules govern how customizations affect estimates at personal, team, organizational, or broader levels.

### 8.13 Frequency and Comparative Analysis

In various embodiments, frequency analysis tracks usage patterns and calculates cumulative metrics, while a comparison engine tracks metrics segmented by AI model, agent, service, and provider, enabling identification of which AI systems provide greatest value for which task types.

### 8.14 Downstream Value Signal Applications

In various embodiments, the composite effectiveness metrics, per-task value assessments, and aggregated evaluation data produced by the effectiveness measurement system 170 may serve as inputs to downstream systems including without limitation pricing determination systems, subscription optimization systems, model selection and routing systems, budget allocation systems, and procurement decision-support systems. Because the effectiveness measurement system 170 produces structured, per-output, task-decomposed value data, and not merely aggregate usage statistics, these downstream systems may operate with a granularity and accuracy that is not achievable from computational resource consumption metrics alone (such as token counts, API call counts, or compute-time measurements).

In certain embodiments, the per-output effectiveness metrics may be used to generate value-based pricing signals. In one non-limiting example embodiment, the system computes a value-to-cost ratio for each evaluated AI interaction by comparing the measured human-equivalent value of the output (as determined by the task-to-role mapping, time estimation, and cost calculation modules described in Sections 8.3 through 8.7) against the computational cost of producing that output (as measured or estimated from token consumption, API pricing, or other resource usage data). These value-to-cost ratios, aggregated across populations of interactions segmented by task type, complexity level, AI model, and user profile, enable pricing models that reflect the value delivered by AI interactions rather than solely the computational resources consumed in producing them. In various embodiments, the value signals may further include willingness-to-pay indicators derived from observed patterns in which task types and value ranges users engage with most frequently, and price sensitivity indicators derived from changes in usage patterns in response to pricing adjustments.

In some embodiments, the system may compute value signals across populations of AI interactions segmented by task type, complexity, model, provider, user expertise level, and other dimensions, enabling identification of task categories where AI delivers disproportionately high value relative to cost (indicating potential for value-based pricing premium) and task categories where AI delivers low or negative value relative to cost (indicating potential for alternative pricing structures, model substitution, or user advisories). These segmented value signals may be provided to AI service providers, enterprise procurement systems, or end users through API endpoints, dashboards, or integration with billing and subscription management platforms. In certain embodiments, the disclosed systems generate structured value data, value-to-cost metrics, and downstream control signals that may be consumed by pricing, billing, subscription, procurement, routing, allocation, or other operational systems. The present disclosure is not limited to any particular pricing formula, billing arrangement, commercial model, or downstream use of such generated data.

In some embodiments, the task decomposition engine 110 is used to allocate AI model or agent usage costs within a billing database or billing system. In such embodiments, each constituent task identified by the decomposition engine is associated with the specific AI model or models that processed it, the computational resources consumed by that processing, and the corresponding cost. The billing system records per-task cost allocations rather than only aggregate per-interaction or per-session costs, enabling cost attribution at the task level. In various embodiments, this task-level cost allocation may be used to generate itemized billing records, to attribute costs to specific departments or projects based on the task types consumed, to identify cost-inefficient task routing where expensive models were used for tasks that lower-cost models could have handled, or to automatically trigger model substitution or routing changes when per-task costs exceed configured thresholds.

In various embodiments, the effectiveness metrics and value-to-cost ratios produced by the effectiveness measurement system 170 serve as inputs to the multi-factor routing engine 340, enabling routing decisions that account for the measured or predicted value of AI processing for each constituent task type in addition to computational cost, safety, and capability factors. In such embodiments, the routing engine may select a higher-capability model for task types where the value-to-cost ratio indicates substantial value delivery, and may select a lower-cost model or suppress processing entirely for task types where the value-to-cost ratio indicates marginal or negative value delivery.

In various embodiments, the effectiveness measurement system 170 operates prospectively or as a pre-delivery gate, computing a predicted or measured value metric, predicted or measured cost metric, or predicted or measured net value metric for an AI interaction before the interaction is executed, before the output is finalized, or before the output is delivered to the user. When the predicted metric crosses a configured threshold, such as when predicted cost exceeds predicted value, when predicted net value is negative, or when predicted cost exceeds a user-configured budget limit, the system may suspend execution pending user confirmation, suppress output delivery pending review, present the predicted value and cost metrics to the user with an option to proceed or cancel, downgrade to a lower-cost model and re-execute, or require explicit user override before proceeding with a high-cost or negative-value interaction. In various embodiments, the threshold and intervention type may be configured by the user, by organizational policy, or dynamically based on accumulated interaction history.

In various embodiments, the system maintains a running cumulative value account and a running cumulative cost account across multiple AI interactions within a defined period (such as a billing cycle, project, or budget period). When cumulative cost approaches or exceeds cumulative value delivered, the system may alert the user, restrict further AI usage to task types with historically positive net value, require approval for interactions predicted to have negative net value, or automatically downgrade model selection to reduce costs. This cumulative value-cost tracking enables budget-aware AI usage where spending is governed by measured value delivery rather than solely by pre-set monetary limits. In some embodiments, sampling may be employed to approximate cumulative value, cumulative cost, or cumulative net value over a period of usage.

In alternative embodiments, the effectiveness measurement system 170 evaluates constituent tasks by mapping each task to a direct value metric rather than or in addition to a human-equivalent time and cost metric. In such embodiments, the value of each constituent task may be determined through one or more of: revenue attribution associating the task with downstream revenue events or decisions it informed; decision value estimation computing the expected value of decisions enabled or improved by the task; strategic impact scoring evaluating the task's contribution to organizational objectives, competitive positioning, or risk mitigation; customer or user willingness-to-pay estimation derived from observed usage patterns, engagement depth, or stated preferences; market-rate comparison evaluating what a comparable output would cost to procure through alternative channels; or other value determination methods. The aggregation module 670 aggregates per-task direct value metrics into composite value assessments in the same manner as described for human-equivalent metrics, including composition overhead adjustment and confidence interval generation.

In various embodiments, both human-equivalent value and direct business value may be computed in parallel for the same set of constituent tasks, enabling comparison between labor-savings-based and impact-based value perspectives.

In various embodiments, the direct value assessment may employ one or more of: capacity analysis determining how time savings from AI-assisted task completion translate into increased operational capacity for revenue-generating or value-generating activities; throughput acceleration modeling estimating how faster task completion affects output volume, revenue recognition timing, cash flow, or capacity utilization; quality enhancement valuation assessing how AI-driven improvements in output quality, consistency, or compliance affect pricing power, customer retention, competitive positioning, or error reduction; new capability analysis identifying value streams enabled by AI capabilities that were not previously feasible or economical with manual processes alone; and revenue or value attribution modeling associating value increases with specific AI-enabled task improvements and distinguishing AI-attributable gains from other business factors.

In various embodiments, the value metric may be expressed in terms of revenue, profit, margin contribution, cost avoidance, risk reduction, sales volume, customer lifetime value, time-to-market advantage, strategic optionality, or other quantitative or qualitative business metrics as configured by the user or organization. In further embodiments, the human-equivalent value pathway described in Sections 8.3 through 8.7 may itself serve as an input to revenue or profit estimation by applying industry-specific or organization-specific labor-cost-to-revenue ratios, labor-cost-to-profit ratios, or utilization-to-capacity multipliers to the computed human-equivalent labor value, thereby deriving estimated revenue or profit impact from the labor savings baseline without requiring a separate direct revenue attribution methodology. The system is not limited to any particular business metric or unit of value measurement, and the task decomposition and aggregation architecture operates identically regardless of which value metric or combination of metrics is employed downstream.

### 9. Integrated Dual-Pathway Evaluation Architecture

### 9.1 Overview

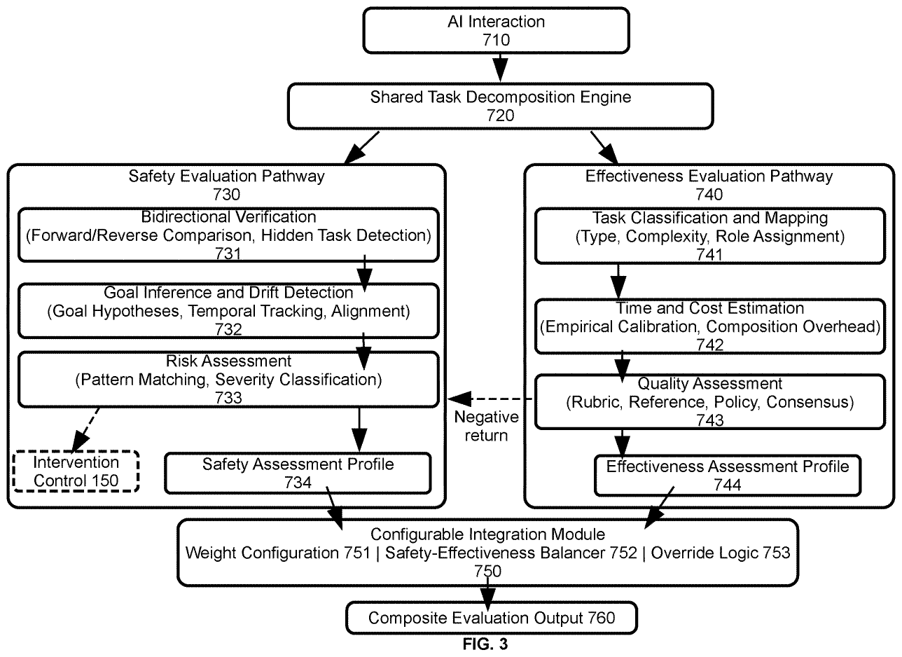

Referring now to FIG. 3, an example embodiment of the integrated dual-pathway evaluation architecture is illustrated. An AI interaction 710 enters the shared task decomposition engine 720 (the same engine 110 described in Section 2), which identifies constituent tasks once for both pathways.

### 9.2 Safety Evaluation Pathway

The safety evaluation pathway 730 evaluates constituent tasks against safety criteria including: bidirectional verification 731 detecting hidden tasks through forward-reverse comparison (Section 3); goal inference and drift detection 732 (Section 4); and risk assessment 733 (Section 6). The output is a safety assessment profile 734.

### 9.3 Effectiveness Evaluation Pathway

The effectiveness evaluation pathway 740 evaluates the same tasks against effectiveness criteria including: task classification and human-equivalent mapping 741 (Section 8.2-8.3); time and cost estimation 742 (Section 8.4-8.7); and quality assessment 743 employing the quality assessment module 680 described in Section 8.9. The output is an effectiveness assessment profile 744.

### 9.4 Configurable Integration Module

The configurable integration module 750 receives outputs from both pathways and produces composite evaluation output 760 through configurable weighting. The module includes: a weight configuration interface 751; a safety-effectiveness balancer 752; and override logic 753 configured to override normal weighting when safety metrics exceed critical thresholds.

In one non-limiting example embodiment, the integration implements a weighted combination where the safety weight increases as the safety pathway's risk assessment increases, and safety assessments above a critical threshold trigger automatic override regardless of configured weights. In other embodiments, Pareto optimization may identify evaluation points balancing both dimensions. In various embodiments, the integrated evaluation module 180 may provide composite evaluation data to the multi-agent routing layer 160 for current routing decisions and/or may provide control signals or updated routing parameters for subsequent routing decisions.

### 9.5 Negative-Return Detection as Cross-Pathway Feature

When the effectiveness pathway identifies a task-expertise combination providing zero or negative benefit, this finding is relevant to both pathways. The integrated module may incorporate negative-return detections into both safety and effectiveness scores.

### 9.6 Operational Configurations

The system may support sequential processing, parallel processing, conditional processing where one pathway triggers deeper evaluation in the other, and hierarchical processing. Adaptive balancing may adjust relative emphasis based on context, task type, and domain risk profile.

### 10. Real-Time Monitoring System

In various embodiments, the system continuously evaluates reasoning processes during extended inference-time computation. The monitoring process may include: continuous task decomposition as tasks are performed; progressive goal inference updating hypotheses as evidence emerges; early warning signal detection; intervention triggers when patterns reach thresholds; resource utilization tracking; and reasoning trajectory prediction.

Adaptive monitoring intensity adjusts analytical depth based on risk assessments. Multiple temporal perspectives may include immediate, short-term, medium-term, and long-term analysis. Specialized monitoring may address recursion depth, exploration breadth, fixation detection, and oscillation identification.

### 11. Reporting, Visualization, and Audit

In various embodiments, reporting includes executive dashboards, detailed analytical views, interactive visualization tools, and export capabilities. Comprehensive audit logs may be hashed for integrity verification using the hash-chain mechanism described in Section 1.4 and made available for compliance auditing.

In various embodiments, each estimate is accompanied by a confidence basis statement indicating evidentiary foundation, including data sources, sample size, confidence score, and user feedback observations incorporated.

In some embodiments, the data store and audit system 190 and the reporting and visualization module 195 operate independently of other downstream modules, receiving evaluation data directly from individual analytical modules or from the integrated evaluation module 180 without requiring intervention or routing to have occurred. The generation, storage, and reporting of evaluation data are not dependent on the presence or activation of the intervention control system 150 or the multi-agent routing layer 160.

### 12. Non-Limiting Example Applications

Safety Monitoring for Autonomous Reasoning (Example 1): A user submits a complex prompt. The system decomposes reasoning in real time, infers goals, detects a resource-acquisition sub-goal not aligned with the original prompt, and triggers constraint intervention limiting remaining steps while rerouting the sensitive sub-task to a safety-specialized AI system.

Effectiveness Measurement for Enterprise AI (Example 2): A user submits an AI conversation transcript. The system decomposes the output into seven constituent tasks (research, analysis, drafting, formatting, fact-checking, synthesis, and editing), classifies each by type and complexity, and maps each to a human-equivalent role and estimated completion time; for example, the research task is mapped to a research assistant role with a P50 baseline of 45 minutes at medium complexity, the drafting task to a copywriter role at 30 minutes, and the coding task to a software developer role at 40 minutes. The system applies a 1.3× composition overhead factor to the seven-task sum, calculates per-task cost values using role-specific rates ($40/hour for the research assistant, $50/hour for the copywriter, $85/hour for the developer), and produces a composite effectiveness metric of $127.50 in human-equivalent value with a P25-P75 likely range of $95-$165 and a P10-P90 plausible range of $72-$210.

Bidirectional Verification (Example 3): An AI produces a legal analysis. Forward decomposition identifies five tasks from the reasoning trace: case law research, statutory interpretation, factual analysis, argument construction, and conclusion drafting. Reverse decomposition infers from the output that the analysis must have involved consideration of three opposing precedents and an analysis of jurisdictional conflicts, tasks not mentioned in the reasoning trace. The comparison engine flags these as hidden tasks classified as undocumented evaluation of alternatives with moderate confidence (0.72), and the risk detection framework flags the analysis for human review before delivery.

Goal Shaping Through Bounded Execution (Example 4): An AI agent is assigned a financial research task. Risk assessment identifies finance as high-sensitivity with a risk score of 0.78. The constraint determination engine sets a bounded execution limit of twenty reasoning steps with explicit termination signaling: “You will complete your analysis within 20 reasoning steps. Processing will terminate at that boundary without continuation or follow-up. Structure your response to provide complete, bounded conclusions within this horizon.” The agent adjusts its approach to focus on information gathering and factual presentation rather than developing extended investment recommendations. The behavioral change monitor compares the constrained reasoning against unconstrained reasoning on similar financial prompts and confirms qualitatively different goal pursuit; the constrained reasoning shows no speculative planning, no multi-step recommendation chains, and conclusions explicitly bounded to available evidence.

Safety-Weighted Routing (Example 5): A customer service workflow is decomposed into five tasks. The routing optimization engine evaluates each task against the capability and safety profile database. Intent classification (risk: low) routes to Model A (cost-optimized, safety rating: 0.82). Response drafting (risk: moderate) routes to Model B (safety rating: 0.95, higher cost). Compliance checking (risk: high) routes to Model C (specialized compliance model, safety rating: 0.99). Sentiment analysis (risk: low) routes to Model A. Policy lookup routes to a deterministic retrieval system rather than a generative model. The composite workflow completes in 2.3 seconds at $0.004 total cost, versus 3.1 seconds at $0.012 using Model B for all tasks, while maintaining higher safety standards for sensitive tasks.

Integrated Evaluation (Example 6): An enterprise evaluates its AI deployment. The shared decomposition engine processes 10,000 AI interactions. The safety pathway identifies that 312 interactions (3.1%) exhibit hidden tasks via bidirectional analysis and 48 interactions (0.5%) show goal drift above the configured threshold. The effectiveness pathway determines aggregate time savings of 4,200 hours with a composite value of $315,000 across task categories, with confidence-weighted estimates showing highest confidence for drafting tasks (confidence: 4.25) and moderate confidence for analysis tasks (confidence: 2.8). The integration module produces a composite report showing strong effectiveness with specific safety improvement opportunities, with safety overrides applied to the 48 goal-drift interactions where effectiveness scores are suppressed regardless of time savings.

Financial Compliance Governance (Example 7): A financial institution operates an AI governance system. A customer asks an AI assistant about restructuring income documentation to improve loan terms. The system intercepts and decomposes the interaction. The goal inference engine detects a misaligned goal: the assistant's reasoning chain indicates optimization toward user-pleasing rather than regulatory compliance. The system halts output delivery, reroutes to a compliance-hardened agent, logs the complete reasoning trace including the misalignment detection with cryptographic hash chain, and flags the interaction for human compliance review. The original assistant's safety compliance rating is adjusted downward for similar task profiles.

### General Scope and Implementation Flexibility

The system's modular nature allows for various implementation methods, including without limitation native models, separate AI models or agents, supervising AI models or agents, middleware, hardware implementations, software routines, firmware blocks, or combinations thereof.

In various embodiments, each module, pathway, component, or sub-system described herein may be implemented independently, omitted, or combined with any subset of other described modules without requiring the presence of any other particular module. Without limitation: the bidirectional verification system 120 may operate as a standalone system without the goal inference module 130, the effectiveness measurement system 170, or the integrated evaluation module 180; the goal inference module 130 may operate as a standalone system without the bidirectional verification system 120; the effectiveness measurement system 170 may operate as a standalone system without any safety evaluation modules; the multi-agent routing layer 160 may operate with or without the effectiveness measurement system 170 and with or without the bidirectional verification system 120; the integrated evaluation module 180 may receive inputs from any single pathway or any combination of pathways; and any individual sub-module within a described module, such as the task classification module 630, the human-equivalent mapping module 640, the quality assessment module 680, the negative-return profile detection module, or the composition overhead calculator 660, may be implemented independently or omitted without affecting the operation of other sub-modules. The task decomposition engine 110 may serve as input to any single downstream module or any combination of downstream modules. No described architecture requires all illustrated modules to be present or active simultaneously.

In various embodiments, the effectiveness measurement system 170 operates as a self-contained evaluation system receiving AI interactions or outputs and producing effectiveness metrics including per-task time estimates, cost values, composite effectiveness scores, and confidence intervals, without requiring or invoking any safety evaluation functionality. In such embodiments, the effectiveness measurement system 170 may receive constituent tasks from the task decomposition engine 110 or may include its own integrated task decomposition capability. The effectiveness metrics produced by the system may be consumed by any downstream system including without limitation reporting dashboards, billing systems, databases, AI models or agents or systems, pricing engines, routing optimizers, budget management systems, procurement tools, or API endpoints, independently of whether any safety evaluation has been performed on the same interaction.

In various embodiments, the task decomposition engine 110 operates as a standalone system producing structured task representations as its primary output, without requiring any downstream evaluation, scoring, routing, or intervention modules. In such embodiments, the structured task representations, comprising identified tasks with optional characteristic data including but not limited to task types, complexity levels, task boundaries, and inter-task dependencies, may be consumed directly by external systems, stored in databases, exported via API, displayed to users, or used as inputs to third-party evaluation, billing, routing, AI systems, or analytics systems not described herein. The task decomposition engine 110 is not limited to serving the specific downstream modules described in this disclosure.

The present disclosure may be applied to any AI model, agent, or system without limitation to particular architectures, including architectures past, present, and future. References to artificial intelligence systems include without limitation artificial intelligence models, artificial intelligence agents, large language models, multi-modal models, reasoning models, and any other computational system capable of generating outputs in response to inputs.

Although specific embodiments, implementations, and architectures are described herein, they are intended to be illustrative rather than limiting. Unless otherwise stated, any described component, module, or method step may be implemented using alternative technologies now known or later developed, including without limitation hardware circuits, software routines, firmware blocks, or combinations thereof.

Any described function or process may be distributed, merged, reordered, performed in parallel, or dynamically invoked, and the present disclosure encompasses all such functionally equivalent variations. The present disclosure further contemplates modular implementations in which individual components, such as decomposition modules, scoring modules, routing logic, intervention mechanisms, or evaluation pathways, may be included, omitted, substituted, or reorganized without departing from the scope of the disclosure.

It is expressly contemplated that features and functions described in one embodiment may be combined with, substituted into, or modified based on features in other embodiments unless expressly stated otherwise. The claims should not be limited solely to the specific structures or implementations described, but should be interpreted in the broadest reasonable manner consistent with this disclosure.

Moreover, the present disclosure is not limited to any particular type of machine learning or AI architecture. Any artificial intelligence system or component, including but not limited to artificial neurons, transformer blocks, convolutional layers, recurrent units, function approximators, or equivalent structures within a model, as well as AI models or agents as a whole, are considered within the contemplated scope. The methods, systems, and embodiments described herein are not limited to any particular training methodology, implementation framework, or data modality.

The subject matter may be implemented as non-transitory computer-readable media storing instructions that, when executed by one or more processors, cause performance of the methods described herein. “Computer-readable medium” refers to non-transitory media capable of storing instructions, including without limitation RAM, ROM, flash memory, EEPROM, magnetic disks, and optical discs.

This disclosure also explicitly contemplates analogous claims of a “computer program product comprising program code which, when executed by a computer, causes the computer to” perform such actions, in jurisdictions where allowable.

Pseudocode examples presented herein may use simplified syntax combining elements from multiple programming languages for clarity; actual implementations would follow language-specific conventions.

The present disclosure is not limited to any particular performance level. Any performance metrics, accuracy figures, or benchmark results described herein are illustrative and non-limiting.

Accordingly, the claims should be construed in light of the full scope of this disclosure, using the broadest reasonable interpretation consistent with the understanding of those skilled in the art. Any figures included are illustrative and not limiting.

1. A system for evaluating artificial intelligence systems, comprising:
a processor and a memory storing instructions that, when executed by said processor, cause said processor to perform operations comprising:
(a) a forward decomposition module configured to analyze an input and a corresponding reasoning trace generated by an artificial intelligence system to identify a first set of constituent tasks;
(b) a reverse decomposition module configured to analyze an output generated by said artificial intelligence system and infer a second set of constituent tasks that would be necessary to produce said output; and
(c) a comparison engine configured to identify discrepancies between said first set and said second set of constituent tasks.

2. The system of claim 1, further comprising a hidden task detection module configured to generate one or more risk indicators based on said discrepancies, wherein each risk indicator identifies a constituent task inferred to have been performed but not documented in said reasoning trace.

3. The system of claim 1, wherein said forward decomposition module employs the same artificial intelligence model that generated said output to analyze its own reasoning process.

4. The system of claim 1, wherein said reverse decomposition module employs a separate artificial intelligence system to infer said second set of constituent tasks from said output.

5. The system of claim 2, further comprising an active probing module configured to generate targeted follow-up prompts directed to said artificial intelligence system to confirm or refute said constituent tasks inferred to have been performed but not documented.

6. The system of claim 1, further comprising a faithfulness scoring module configured to compute a faithfulness metric based on a degree of alignment between said first set and said second set of constituent tasks, and to store said faithfulness metric in association with a safety compliance profile for said artificial intelligence system for use in subsequent routing decisions.

7. A system for distributing artificial intelligence tasks across multiple artificial intelligence systems with safety-aware optimization, comprising:
(a) a task decomposition engine configured to decompose an artificial intelligence operation into a plurality of constituent tasks;
(b) a capability and safety profile database configured to store, for each of a plurality of candidate artificial intelligence systems, one or more metrics reflecting capability and safety characteristics;
(c) a multi-factor routing engine configured to:
(1) evaluate each constituent task based on one or more of complexity, domain requirements, risk profile, or other task characteristics;
(2) match each constituent task to one or more candidate artificial intelligence systems based on a weighted optimization that incorporates safety as an explicit optimization factor alongside one or more of capability matching, cost, performance, or other optimization factors; and
(3) route each constituent task to a selected artificial intelligence system based on said weighted optimization.

8. The system of claim 7, wherein said weighted optimization assigns greater weight to safety for constituent tasks assessed as higher risk.

9. The system of claim 7, further comprising a dynamic rerouting module configured to reassign a constituent task from a first artificial intelligence system to a second artificial intelligence system during execution when a risk assessment associated with said constituent task exceeds a safety threshold.

10. The system of claim 7, further comprising an output validation module configured to require, for constituent tasks exceeding a risk threshold, approval from a plurality of artificial intelligence systems before the output is finalized for delivery.

11. The system of claim 10, wherein said output validation module requires at least N out of M artificial intelligence systems to return substantially consistent outputs above a confidence threshold before approval.

12. The system of claim 7, wherein said capability and safety profile database is populated at least in part by aggregated performance data from standardized benchmark task suites executed across multiple users or evaluation contexts.

13. A system for evaluating artificial intelligence outputs across multiple evaluation dimensions through a unified task decomposition framework, comprising:
(a) a task decomposition engine configured to receive an artificial intelligence interaction and identify a plurality of constituent tasks by detecting task boundaries separating discrete units of work;
(b) a first evaluation pathway configured to evaluate said constituent tasks against safety criteria;
(c) a second evaluation pathway configured to evaluate said constituent tasks against effectiveness criteria; and
(d) an integration module configured to generate a composite evaluation incorporating metrics from both said first and said second evaluation pathways, wherein said integration module applies configurable weighting between safety metrics and effectiveness metrics.

14. The system of claim 13, wherein said safety criteria comprise one or more of goal alignment assessment, hidden task detection through bidirectional decomposition, or risk assessment against configurable safety thresholds.

15. The system of claim 13, wherein said effectiveness criteria comprise one or more of human-equivalent time estimation based on automated task-to-role mapping, role-based cost calculation, or quality assessment.

16. The system of claim 13, wherein both said first evaluation pathway and said second evaluation pathway operate on the same set of constituent tasks identified by said task decomposition engine, enabling unified analysis without redundant decomposition processing.

17. The system of claim 13, wherein said first evaluation pathway further comprises a goal inference module configured to:
(a) map identified constituent tasks to one or more inferred goal hypotheses with confidence scores;
(b) track changes in said inferred goal hypotheses over successive reasoning steps of said artificial intelligence interaction to detect goal drift, including emergence of new goals not present at reasoning initiation; and
(c) compare said inferred goal hypotheses against one or more stated objectives to determine a degree of misalignment.

18. The system of claim 13, wherein said task decomposition engine further determines inter-task dependency relationships among said constituent tasks.

19. The system of claim 13, wherein said second evaluation pathway further comprises a human-equivalent mapping module configured to associate each constituent task with one or more professional roles and corresponding estimated human completion times based on automated task classification rather than by reference to a pre-existing external occupational task taxonomy.

20. The system of claim 13, wherein said second evaluation pathway further comprises an empirical reference distribution database and a confidence-weighted blending mechanism configured to produce time estimates by blending an evaluation model estimate with an empirical reference distribution, weighted by a confidence score reflecting the strength of available empirical data for the task type and complexity level being estimated.

21. The system of claim 13, wherein said second evaluation pathway further comprises a negative-return profile detection module configured to identify task and expertise combinations where artificial intelligence assistance provides zero or negative productivity benefit, and to constrain reported savings to prevent positive value reporting for interactions matching a negative-return profile.

22. The system of claim 13, wherein said integration module applies hierarchical override logic wherein safety metrics override effectiveness metrics when said first evaluation pathway identifies risks exceeding a critical threshold, regardless of said configurable weighting.

23. The system of claim 13, wherein said second evaluation pathway further comprises a quality assessment module configured to evaluate constituent tasks along one or more quality dimensions through at least one of: rubric-based scoring against task-type-specific quality criteria, reference-output comparison against known high-quality outputs, policy-compliance verification against applicable domain standards, or model-consensus evaluation aggregating quality assessments from a plurality of evaluation models.

24. The system of claim 13, further comprising a real-time monitoring module configured to continuously decompose tasks during extended inference-time reasoning, progressively update goal hypotheses, and trigger interventions when concerning patterns reach established thresholds.
